(19) United States
(12) Patent Application Publication
(10) Pub. No.: US 2019/0139143 A1
(43) Pub. Date: May 9, 2019

(54) SYSTEMS AND METHODS FOR RATING ASSET OWNER GOVERNANCE

(71) Applicants: FGA - Diagnostics, LLC, Wauwatosa, WI (US); Marquette University, Milwaukee, WI (US)

(72) Inventors: Christopher K. Merker, Wauwatosa, WI (US); Sarah W. Peck, Milwaukee, WI (US)

(73) Assignees: FGA - Diagnostics, LLC, Wauwatosa, WI (US); Marquette University, Milwaukee, WI (US)

(21) Appl. No.: 16/037,009

(22) Filed: Jul. 17, 2018

Related U.S. Application Data
(63) Continuation-in-part of application No. 15/808,556, filed on Nov. 9, 2017.

(51) Int. Cl. G06Q 40/06; G06Q 10/06

(52) U.S. Cl. CPC G06Q 40/06; G06Q 10/06398

(57) ABSTRACT

Methods and systems for rating fiduciaries that govern assets. Governance variables relating to at least one of environmental and social factors for governing the assets that impact performance of the assets and related financial securities are collected. Control variables that also impact the performance are assigned. A collection of actual test values are compiled for the governance variables, the control variables, and the performance for test assets within the assets. A weight factor indicating the impacts on the performance by each of the governance variables and the control variables is assigned. A rating model incorporating the governance variables and the control variables and each respective weight factor is constructed. Actual asset values for the governance variables and the control variables for a given asset within the assets are collected. A given fiduciary within the fiduciaries that governs the given asset is rated using the rating model with the actual asset values collected.

### FIELD

The present disclosure generally relates to asset owner governance, and more particularly to systems and methods for rating fiduciary effectiveness in asset owner governance.

### BACKGROUND

The Background and Summary are provided to introduce a foundation and selection of concepts that are further described below in the Detailed Description. The Background and Summary are not intended to identify key or essential features of the claimed subject matter, nor are they intended to be used as an aid in limiting the scope of the claimed subject matter.

The U.S. and many developed countries are currently facing a retirement savings crisis. Among other issues, the governance of institutional funds, such as public pension plans, is coming under greater scrutiny in light of the systematic and chronic under funding, declining investment returns, and shifts into higher risk asset classes. Many states and local retirement plans are on an unsustainable course, having failed to set aside enough money to fund the promises they have made. A disconnect often exists between an organization's process and the outcome of this process, specifically with regard to the overall effectiveness of the organization's investment performance and funding status.

Unfortunately, statutory fiduciary standards relative to the management of institutional funds by organizations offer little guidance from a process point of view. Today investors, donors, tax payers, and beneficiaries are often poorly equipped to objectively evaluate an organization's fiduciary effectiveness, or to otherwise distinguish the effectiveness of one organization in managing its assets over another.

While behavioral finance research remains a fruitful ground for study, a number of biases are known to impact people's ability to make effective retirement decisions. Some behavioral deficiencies can be neutralized with basic financial literacy, reducing some portion of poor investment decisions. This applies to those making decisions on their own investments, as well as those making decisions on behalf of others, such as trustees of pension boards. However, the issue of objective evaluation of fiduciary processes and effectiveness persists.

### SUMMARY

One embodiment of the present disclosure generally relates to a method for rating fiduciaries that govern assets. Governance variables relating to at least one of environmental and social factors for governing the assets are collected, where the governance variables impact performance for the assets. Control variables are assigned, where the control variables also impact the performance for the assets. A collection of actual test values are compiled for the governance variables, the control variables, and the performance for test assets within the assets. A weight factor indicating the impacts on the performance for the test assets by each of the governance variables and the control variables is assigned. A rating model incorporating the governance variables and the control variables with each respective weight factor is constructed. Actual asset values for the governance variables and the control variables for a given asset within the assets are collected and a given fiduciary within the fiduciaries that governs the given asset is rated by using the rating model with the actual asset values collected.

Another embodiment generally relates to a system for rating fiduciaries that govern assets. The system includes a collection of governance variables that relate to at least one of environmental and social factors for governing the assets, where the governance variables impact financial performance for the assets based on actual test data. The system further includes a collection of control variables, wherein the control variables also impact the financial performance for the assets. A collection of weight factors indicates the impacts on the financial performance for the test assets by each of the governance variables and the control variables. The weight factors are based on actual test values for the governance variables, the control variables, and the financial performance for test assets within the assets. A given fiduciary within the fiduciaries is rated by applying the weight factors to actual asset values collected for the given fiduciary for the governing variables and the control variables.

Another embodiment generally relates to a method for rating fiduciaries that govern funds. The method includes collecting governance variables relating to environmental, social, and governance factors for governing the funds. The governance variables impact financial performance for the funds and collecting the governance variables includes gathering data from meeting minutes of the fiduciaries. Control variables are assigned, where the control variables also impact the financial performance for the funds. A collection of actual test values for the governance variables, the control variables, and the financial performance for test funds within the funds are compiled. The actual test values for the governance variables and the control variables are taken over a test period, and the actual test values for the financial performance are taken over a delayed period that is delayed from the test period. A weight factor indicating the impacts on the financial performance for the test funds by each of the governance variables and the control variables is assigned. Each weight factor of the governance variables and the control variables is normalized and a normalized weight factor is correspondingly assigned for each weight factor. A rating model incorporating the governance variables and the control variables with each respective normalized weight factor is constructed. Actual fund values for the governance variables and the control variables for a given fund within the funds are collected and a given fiduciary within the fiduciaries that governs the given fund is rated by using the rating model with the actual fund values collected.

Various other features, objects and advantages of the disclosure will be made apparent from the following description taken together with the drawings.

### BRIEF DESCRIPTION OF THE DRAWINGS

The drawings illustrate the best mode presently contemplated of carrying out the disclosure. The same numbers are used throughout the drawings to reference like features and like components. In the drawings:

FIG. 1 is a schematic view of an exemplary system in accordance with the present disclosure;

FIG. 2 depicts a process flow of an exemplary method in accordance with the present disclosure;

FIGS. 3-5 depict a detailed process flow for an exemplary method similar FIG. 2;

FIGS. 6a-12 depict exemplary variables and analysis corresponding to certain embodiments in accordance with the present disclosure; and

FIGS. 13a-c depict exemplary variables relating to Environmental, Social, and Governance (ESG) factors.

### DETAILED DISCLOSURE

This written description uses examples to disclose embodiments of the present application, including the best mode, and also to enable any person skilled in the art to practice or make and use the same. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present inventors have identified that the current system of education for financial literacy is inadequate in preparing people for making and managing their financial decisions. This has contributed to generations of Americans who suffer from a lack of essential working knowledge for planning, as well as for household budgeting, management of credit, savings, and investing.

This lack of financial prowess is further exacerbated by the lack of a standard or even effective mechanism for determining the performance of others delegated to assist in managing one's financial affairs. This at least in part arises from the common belief that a fiduciary's actions and behaviors in performing its fiduciary duty in managing a fund is either met, or not met, as in “either-or” proposition. However, by the time a fiduciary's actions have fallen to the point where their fiduciary duties would no longer be met from a legal standpoint, the fund is likely already in dire straights, including significant erosion in financial position, bankruptcy, fraud, litigation, and/or regulatory violations. Public awareness of any of these conditions is not likely to be widespread until it appears as a headline in the news after the fact.

While much research has been done on the proper attributes of a fiduciary or the makeup of a board, many challenges remain. One common issue pointed out in the literature is that independent, outside directors may not have access to all of the necessary information, or the time or inclination to review it, to make effective decisions. Accordingly, many boards have a mix of internal and external board members. Empirical studies have also shown that smaller boards are often more effective.

The role of directors within committees may also play a role in the effectiveness of the board. Specifically, committees should be organized with specialized roles to enhance the board's performance in both its productivity and monitoring functions. Each committee should be set up with a defined set of functions and goals, and be staffed with directors most likely to attain each goal. Common committee structures follow this framework: governance/nominating, audit, compensation, strategy, finance (investments/capital budgeting) and other ad hoc committees. Committees exist to do the work of the board within a task-specific area. They are used to facilitate, evaluate and ratify long-term investment decisions and to monitor the performance of senior management. One would expect productivity-oriented committees to be staffed by insiders and monitoring-oriented committees by outsiders. This is, in fact, how many boards arrange themselves.

Board of director compensation structure is also important for aligning interests of the board with those of shareholders (e.g. stock ownership). Likewise, boards are also responsible for hiring the CEO and other top management, and structuring management compensation. The compensation issue has drawn much ire in recent years as the pay packages of CEOs have become increasingly larger, in many cases despite retention or turnover. It has been a hot button issue, and “say on pay” rights of shareholders have recently been under scrutiny.

Two forms of error are also present in investment management, operational risk and behavioral risk or error in human decision-making. As will become clear, one is very functional in form, and the other is more strategic. Operational risk can be more easily controlled and safeguarded against through audits, procedures and practices. However, behavioral risk is more subjective, ambiguous and difficult to judge in practice, and requires structural and process adjustments to limit it.

The disconnect between fiduciary standards and effectiveness has perverse impact across all major categories of institutional funds: a growing number of failed private pension plans, chronically underfunded state and municipal pension plans, and non-profitable organizations with such poor oversight that they are regularly vulnerable to white collar crime. These widespread problems in our nation's private and public pension system, in both profit and non-profit sectors, illustrate a system of financial management operating at a level that gives cause for real concern.

Previous studies have focused on investment managers, such as the Morningstar and FI360 rating systems. To date, no study has comprehensively examined fiduciary effectiveness of primary institutional fund organizations as a whole, nor applied it so that it can be used in comparing multiple organizations. Certainly, none have focused on an overall fiduciary effectiveness score for the governing fiduciary.

In the publication “The Governance of Public Pensions: An Institutional Framework” (Administration & Society, 1-29, Jan. 28, 2016), authors Matkin, Chen, and Khalid call for a more comprehensive, data-driven approach to understanding public pension finance. This call to action demands two things: 1) more complete datasets are needed to analyze this complex topic; and 2) better ways of analyzing the data to improve both public policy and private sector activity.

The corporate governance methods of analysis and data collection methods of organizational behavior addressed in this paper may hold the keys to answering this call. With this empirical review now completed across a foundational and influential set of asset owners in the U.S., the inventors have the basis for evaluating these organizations and additionally creating new survey methods that may help organizations undertake meaningful self-assessments. Most importantly, the inventors can through these methods equip investors, beneficiaries, donor and taxpayers with the tools to understand, assess and compare these organizations.

To that end, the present inventors have developed the presently disclosed systems and methods to identify and measure key factors that drive fiduciary effectiveness. Information from U.S. public pension plans was used in this initial development as such information is more readily available due to the disclosure requirements, including meeting minutes, agendas, financial statements, and other required information. This data is often posted on fund websites, or is otherwise available through public databases such as the Boston College Public Retirement Plans database. Through the data collected, factors were identified and a model created to provide explanatory power on whether an organization is at risk of significant under funding or other fiduciary problems, such as bankruptcy, civil litigation, regulatory violation, or crime. In this regard, the composite rating of fiduciary effectiveness subsequently allows the construction of an index of relative measures, making organizations comparable side-by-side.

The presently disclosed rating system, a measure of overall effectiveness, is referred to herein as the fiduciary effectiveness quotient or FEQ. When the measure applies specifically to an individual as a fiduciary (or as part of a larger fiduciary), the score is also referred to as a member effectiveness quotient or MEQ. A higher score is indicative of stronger forms of governance, and structures within, the fiduciary, as well as overall greater fiduciary effectiveness.

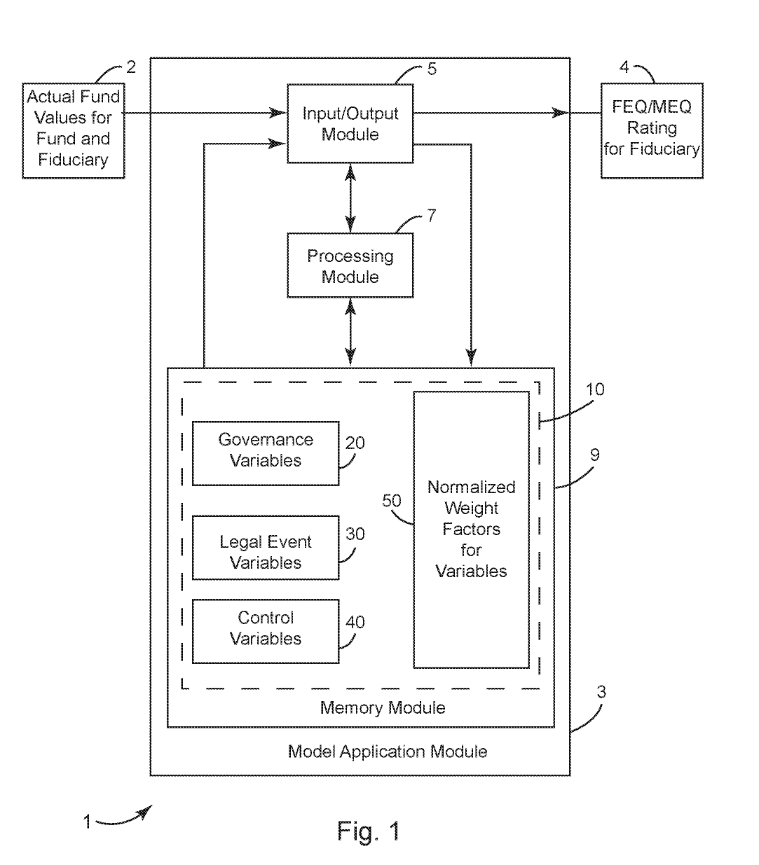

FIG. 1 depicts a high level view of one exemplary embodiment for rating asset owner governance, or rating fiduciaries that govern funds, in accordance with the present disclosure. It should be noted that the term “fiduciary,” while often used in the context of a board or group of individuals, relates to any person or entity (or group thereof) having a fiduciary duty. In other words, a fiduciary includes a board, an organization, a committee, an individual, a government agency, a third party consultant or advisor, or any other person or entity or group of such tasked with governing a fund. By way of non-limiting example, funds include portfolios of real or financial assets, including financial securities such as bonds or stocks, or other assets that the fiduciary is charged with managing or overseeing. Although funds may also include liabilities, the foregoing will sometimes be collectively referred to as an asset for brevity.

In the embodiment shown, the system 1 provides a model application module 3 that generates an FEQ or MEQ rating 4 output for a fiduciary based on actual fund values 2 inputted for a fund and fiduciary. In particular, actual fund values 2 for a fund and fiduciary are inputted via an input/output module 5 within the model application module 3. The input/output module 5 is in communication with a processing module 7, as well as with a memory module 9.

The memory module 9 is configured to store a model 10 as presently disclosed, which incorporates governance variables 20, legal event variables 30, control variables 40, and normalized weight factors for variables 50. As will be discussed below, non-normalized weight factors may also be stored within the model 10 in the memory module 9. Likewise, not all embodiments include the elements shown, such as legal event variables 30. Through communication with the memory module 9, the processing module 7 applies the actual fund values 2 for the fund and fiduciary in the model 10 to output, via input/output module 5, an FEQ or MEQ rating 4 for the fiduciary.

Certain aspects of the disclosure are described herein in terms of functional and/or logical block components and various processing steps. It should be recognized that any such functional and/or block components and processing steps may be realized by any number of hardware, software, and/or firmware components configured to perform the specified functions. For example, certain embodiments employ various integrated circuit components, such as memory elements, digital signal processing elements, logic elements, look-up tables, or the like, which are configured to carry out a variety of functions under the control of one or more processors or other control devices. The connecting lines shown in the various figures contained herein are intended to represent example functional relationships and/or physical couplings between the various elements. It should be noted that many alternative or additional functional relationships or physical connections may be present in a practical embodiment.

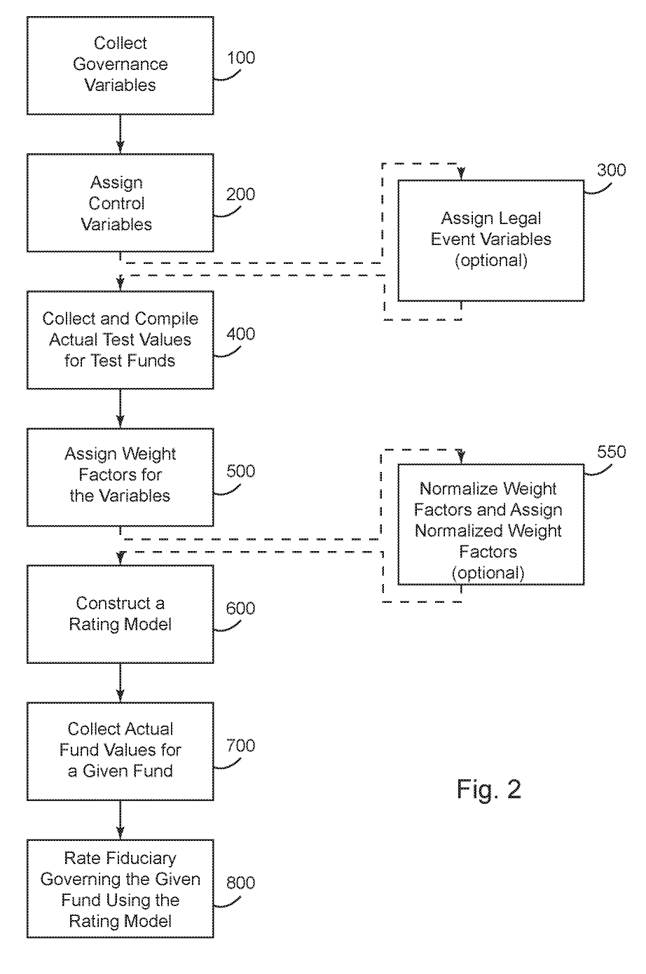

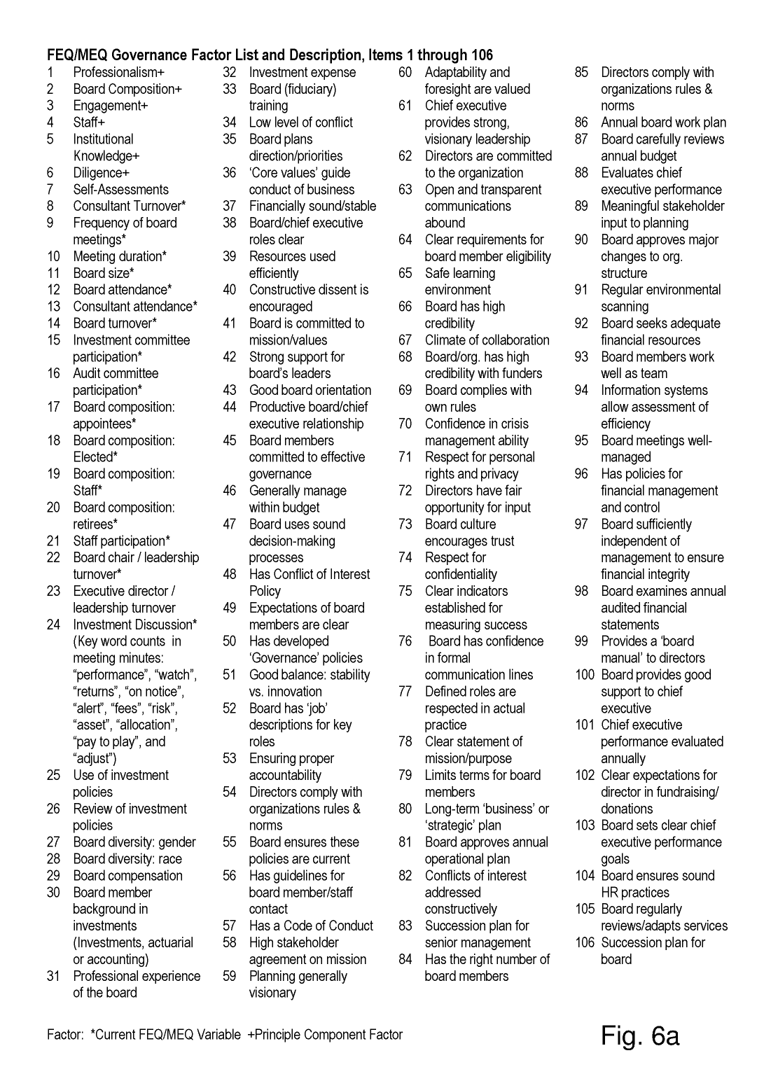

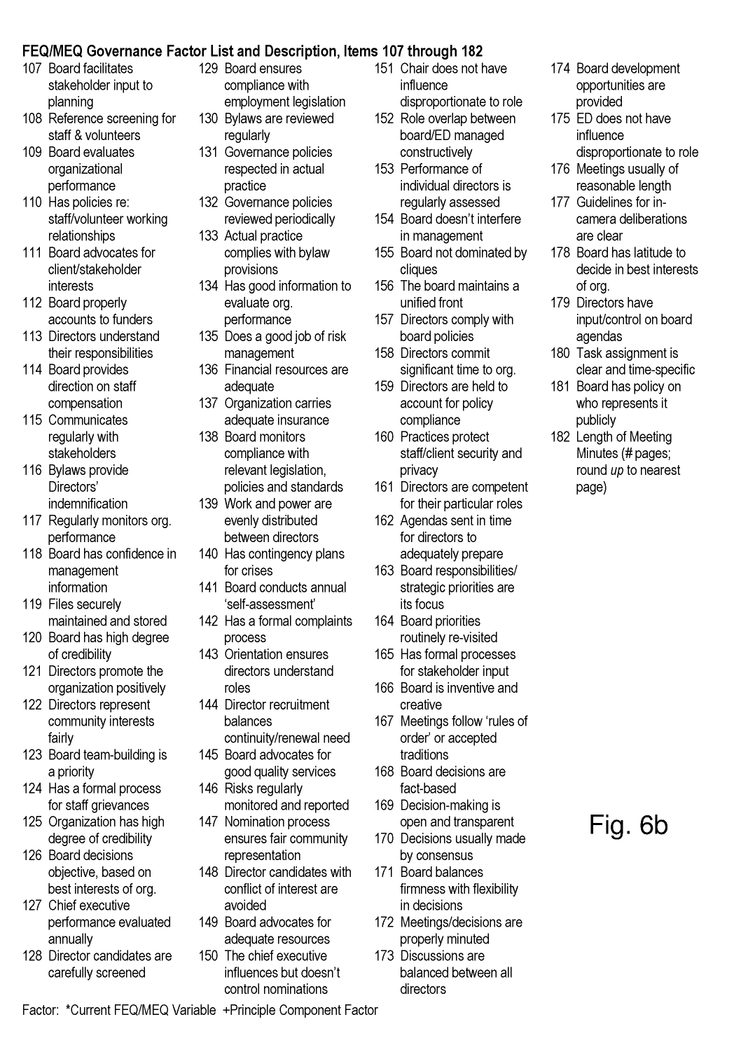

FIG. 2 depicts an exemplary method for generating the model 10 for rating fiduciaries in accordance with the present disclosure. To begin, governance variables relating to governing the funds are collected in step 100, whereby governance variables impact the financial performance for the funds. These may include the frequency of meetings, the diversity of fiduciary members with respect to gender or race, whether a board is given training or practices core values, whether there is a formal complaint process and others. In certain embodiments, which are discussed below, additional focus on diversity is provided beyond fiduciary members, specifically characterizing an organizations' performance with respect to “social” concerns within governance. A non-exhaustive list of governance variables is provided in FIGS. 6a, 6b, 8a, and 9a. It should be noted that the values collected for some or all variables (for example “good board orientation”) may also be licensed or otherwise obtained from other sources to be integrated into the presently disclosed systems and methods. In some embodiments, integrating data from one or more external sources is useful for streamlining the process of information acquisition.

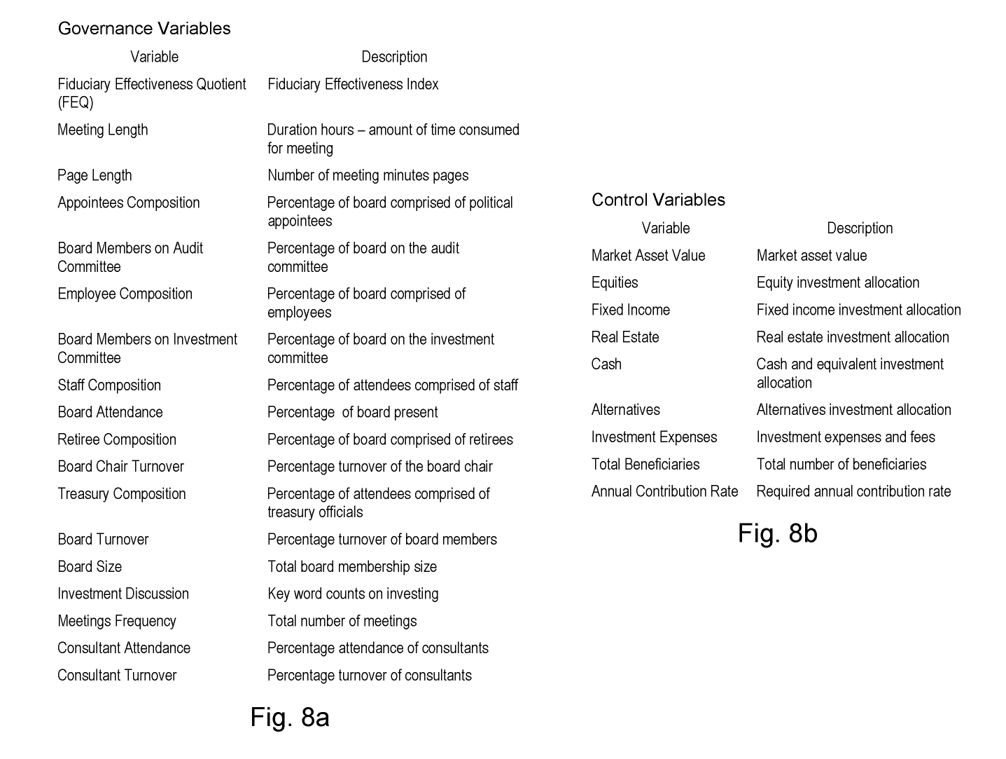

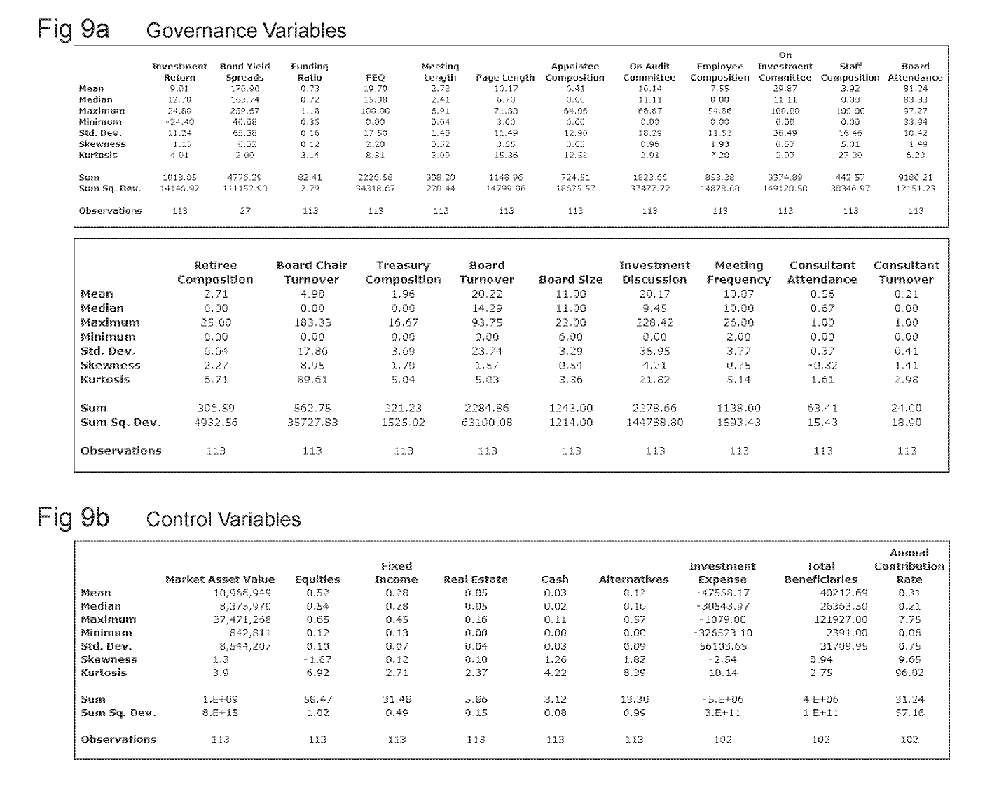

Returning to FIG. 2, control variables are assigned in step 200. The control variables also impact the financial performance of the funds, but do not relate to the fiduciary's governance of the funds. A non-extendable list of exemplary control variables includes the market asset value of a fund, allocations of cash, bonds, stocks of differing economies and cap sizes, and the annual contribution rate, also shown in FIGS. 8b and 9b.

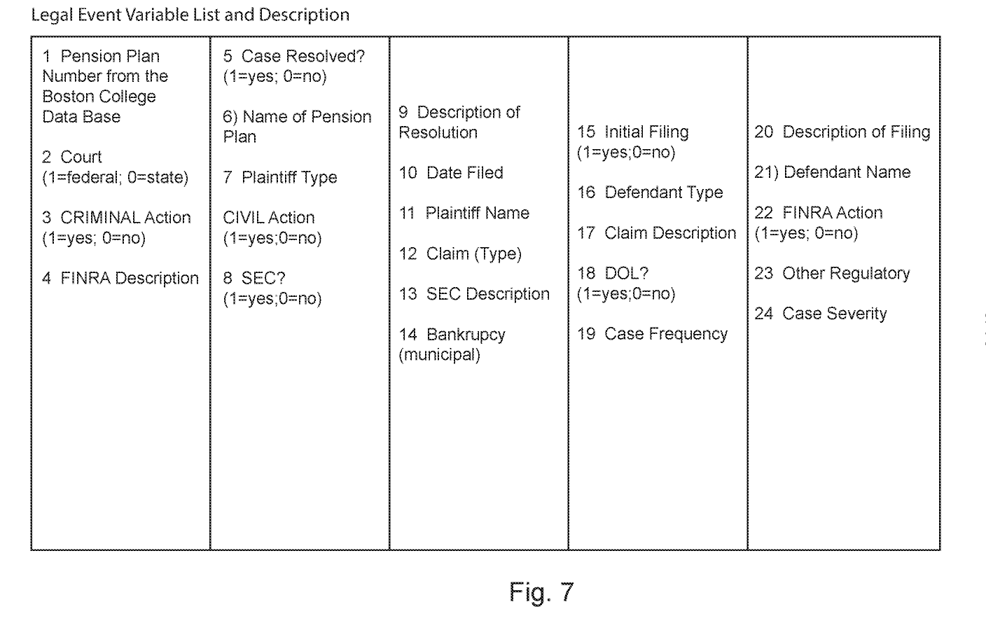

In certain embodiments, legal event variables are also assigned at step 300 as shown in FIG. 2. Where assigned, the legal event variables also impact financial performance for the funds, but relate to activities, investigations, statures, and other variables involving laws, regulations, and the like. These may overlap, or be in addition to an organizations' performance with respect to “environmental” concerns, which are discussed at length below. A non-exclusive list of variables is provided in FIG. 7 and discussed further below. While step 300 is optional, the present inventors have discussed that also assigning legal event variables results in more accurate and comprehensive explanatory power between the actions and behaviors of a fiduciary in governing the funds and the resultant performance of the funds, thereby resulting in a more meaningful rating of the fiduciary. It should be known that while a fiduciary's actions are often discussed herein, refraining from taking one action constitutes taking a different action in and of itself.

Returning to FIG. 2, a group of test funds were then identified from within a greater population of funds and a set of actual test values for the test funds collected and compiled in step 400. Specifically, step 400 includes the collection and composition of actual test values corresponding to the governance variables collected in step 100, the control variables assigned in step 200, and the legal event variables assigned in step 300 (where applicable) for each fund within a group of test funds. Specific examples of the data collected for each variable type are discussed below.

Using statistical analysis techniques, which are also discussed in detail below, weight factors are assigned in step 500 for the variables. The weight factors indicate or represent the impacts on the financial performance of the test funds caused by each of the governance variables, control variables, and legal event variables (where applicable). Each of the weight factors assigned has a magnitude and direction, serving as coefficients for each of these variables for the final model of the present disclosure.

In certain embodiments, each of the weight factors assigned in step 500 is further normalized and assigned to a normalized weight factor in optional step 550. In one embodiment, this is a normalization of each weight factor to a 100 point scale, whereby the “best,” maximum, or most preferred value (as the case may be for a particular variable) is normalized to 100 and the opposite (i.e., “worst”) value normalized to zero within the index for each variable. In some cases, a maximum value may be reversed to correspond to a normalized value of zero such that 100 remains the “best” or most desirable value. For example, the highest value for criminal actions against the fiduciary, (a negative, undesirable event) should be normalized to zero.

Using either the weight factors assigned in step 500 or the normalized weight factors assigned in step 550, a rating model is constructed in step 600 that incorporates the governance variables, the control variables, the legal event variables (where applicable), and each respective weight factor or normalized weight factor. This rating model can then be used to align FEQ or MEQ scores to fiduciaries of specific funds. In particular, actual fund values for a given fund collected are inputted into the rating model in step 700, which in step 800 produces a rating for the fiduciary governing that given fund using the rating model.

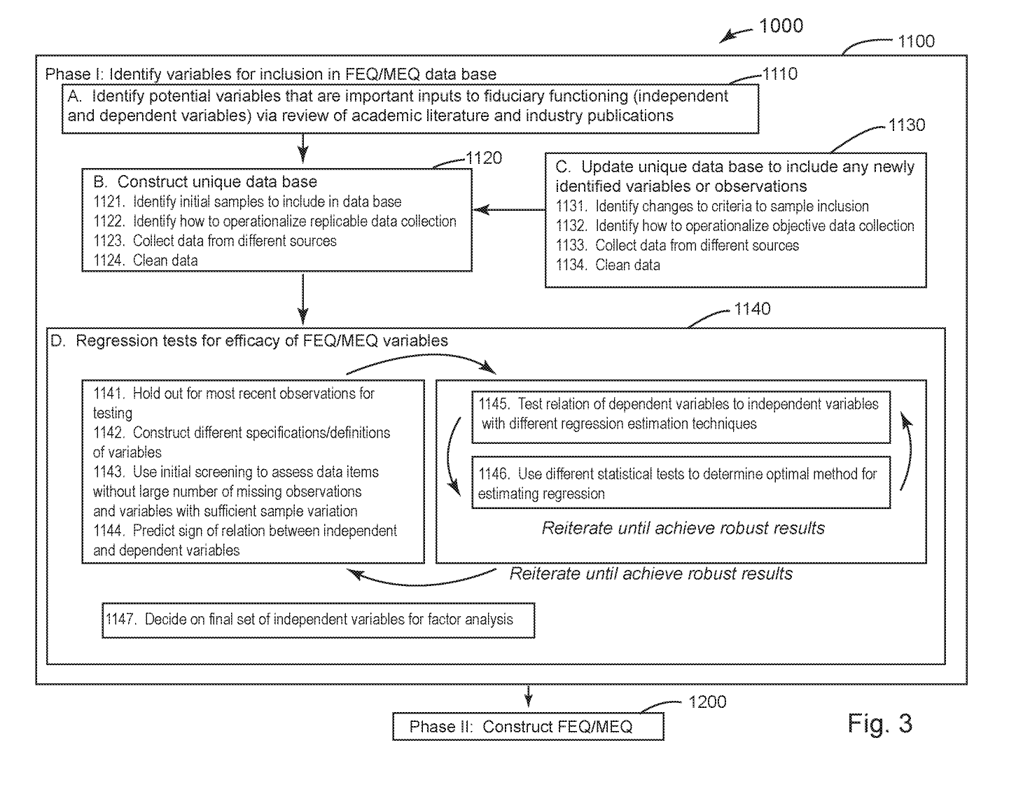

The exemplary method of FIG. 2 is shown in further detail in FIGS. 3 through 5, which also depict the iterative process of producing a rating model that provides high explanatory value of financial performance based on the governance of a particular fiduciary. Method 1000 begins with step 1100 (Phase 1), which is identifying variables for inclusion in the FEQ or MEQ database. Within Phase 1, step 1110 is to identify variables both independent and dependent variables that are likely to be important inputs to fiduciary functioning based on reviews of academic literature and industry publications. These potential variables are used to construct a unique database in step 1120, which also includes the step of identifying initial samples to include in the database, identifying methods to operationalize replicable data collection, collecting data from different sources, and cleaning the data through statistical and other mathematical processes. As will become apparent later, it is often necessary to update this unique database in step 1130 as new variables are identified or new observations are made. This includes identifying changes to the criteria for sample inclusion and how to operationalize objective data collection, collecting data from different sources, and cleaning the data as described in steps 1131 through 1134 of the update process in step 1130.

The unique database constructed in step 1120 is then subjected to regression testing for efficacy of the FEQ or MEQ variables in step 1140. In the present embodiment, the regression testing includes holding out for the most recent observations for testing, constructing different specifications and definitions of variables, using the initial screening to assess data items without large numbers of missing observations and variables with sufficient sample variation, and predicting the sign (i.e., positive or negative) of the relationship between independent and dependent variables on the financial performance of the fund, which are depicted as steps 1141 through 1144. Step 1145 includes testing the relation of dependent variables to independent variables with different regression estimation techniques. Through the use of different statistical tests, the optimal method for estimating regression is determined in step 1146. Further discussion of statistical analysis techniques is provided below. As depicted in FIG. 3, it is often necessary to reiterate through regression testing, both between steps 1145 and 1146, as well as back to steps 1141 through 1144, in order to obtain robust results. Once robust results have been achieved, step 1147 is to decide on a final set of independent variables for factor analysis, which is then used to proceed to Phase 2, constructing the FEQ or MEQ rating model in step 1200.

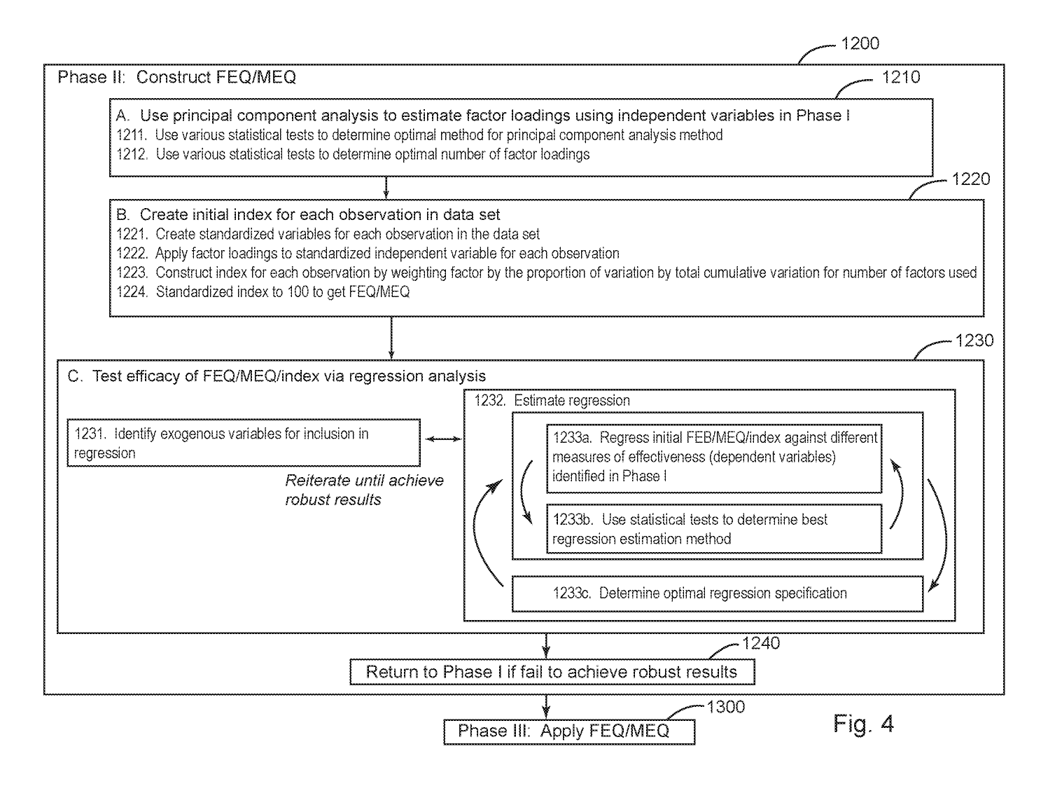

In the embodiment shown in FIG. 4, Phase 2 begins with the use of principal component analysis in step 1210 to estimate the factor loadings of the independent variables from Phase 1. This includes use of various statistical tests to determine the optimal method for principal component analysis method, and the use of various statistical tests to determine the optimal number of factor loadings, depicted as steps 1211 and 1212. These, and other statistical tests and analysis discussed herein, are readily understood by those of ordinary skill in the art.

These determinations are then used to create an initial index for each observation in the data set in step 1220. As previously discussed, this data set may be a set of actual test values taken from a group of test funds within an overall group of funds. For example, the initial index may be based upon observations from a set of thirty individual test funds within an overall group of U.S. public funds.

In steps 1221 through 1224, standardized variables are created for each observation in the data set, whereby factor loadings are applied to standardized independent variables for each observation. The initial index is constructed for each observation by determining a weighting factor by the proportion of variation by total cumulative variation for the number of factors used. In certain embodiments, as discussed above, each weighting factor is then standardized to a normalized weight factor, such as an index of zero to one hundred.

The efficacy of the initial index created in step 1220 is then tested in step 1230, such as through the use of regression analysis. In step 1231, exogenous variables are identified for inclusion in regression, which is reiterated until robust results are achieved in step 1232. The regression estimation may further comprise the steps of regressing the initial FEQ or MEQ index against different measures of effectiveness such as dependent variables, identified in Phase 1, as well as using statistical methods to determine the best regression estimation method for producing the most robust results. Again, those one of ordinary skill in the art are familiar with regression testing and other statistical methods to achieve robust results.

This determination is then used to determine the optimal regression speculation in step 1233c, which is reiterated with step 1231, identifying exogenous variables for inclusion in the regression until robust results are achieved. In some cases, it is necessary to return to Phase 1 if the FEQ or MEQ index continues to not achieve robust results in step 1240. Alternatively, once robust results are achieved, the process moves to Phase 3 in step 1300.

Phase 3 relates to applying the FEQ or MEQ (step 1300), which further includes the step of performing a quintile analysis in step 1310 to measure the differences in FEQ or MEQ independent variables between the top and bottom quintiles. In other words, differences measured in all FEQ or MEQ variables can be compared for fiduciaries in the top 20% in a top 20% of FEQ or MEQ ratings. These differences can then be interpreted to identify differences in fiduciary practices in step 1312, allowing investors and fiduciaries themselves to assess the particular fiduciary practices that result in optimal financial performance as depicted in step 1320. Further leanings from evaluation of fund practices can be incorporated into phase 1 in step 1330, as previously discussed.

While governance factors are limitless and ever-changing, exemplary lists and descriptions are provided in FIGS. 6a, 6b, 8a, and 9a. For example, FEQ (or MEQ) factors may include a board size as depicted by item number 11, or the instances of a key word in meeting minutes, such as “performance,” “alert,” “fees,” or “adjust,” as depicted by item number 24. The factor list and descriptions of FIGS. 6a and 6b further depict whether the listed factor item was included in the previously discussed exemplary FEQ or MEQ model, and whether the particular factor was identified to be a principal component factor, depicted by an asterisk or a plus sign, respectively.

FIG. 7 depicts a non-exhaustive list of exemplary legal event factors and descriptions, along with exemplary logic for incorporating these factors into modeling. For example, item number two would be populated with a one for each event involving a court at the federal level, a zero for each event involving a court at the state level, or be null if no court events were reported. In this example, a “null” entry would be normalized as being “best” on the 100 point scale in the embodiment previously described. Likewise, FIGS. 8a and 8b depict exemplary governance variables and control variables respectively.

FIGS. 9a and 9b further depict descriptive statistics collected for governance variables and control variables, respectively, for a group of test funds within the overall population of funds. The data shown was collected from a group of test funds comprising 35 public pension plans based on data publicly available and objectively replicable. For example, the governance variables shown in FIG. 9a include the mean, median, standard deviation, and other statistical measures for investment return, funding ratios, and the page length of meeting minutes, as well as the corresponding FEQ scores across the group of 35 public pension plans comprising the test funds. Likewise, the control variables in FIG. 9b include the mean, median, and standard deviation, among others, for the market asset value, fixed income, and investment expenses for the 35 public pension plans.

In the embodiment shown, the investment return collected for each of the 35 public pension plans is taken over a delayed time period relative to the data taken for the other variables. Specifically, the data shown reflects a one year delay between the data collected for investment return versus the data collected for governance, legal event variables, and in certain cases control variables. The present inventors adopted the one year delay in this embodiment in recognition of the natural and inherent delay between behaviors of the fiduciary and the consequent result of financial performance for the funds they govern. Data may also be collected and averaged over periods of time to reduce fluctuations and outliers.

It should be recognized that other delays, which may also vary by the specific factor, are anticipated by the present disclosure, whether longer or shorter than the one year delay previously discussed. Moreover, the optimal delay (in addition to varying by factor) may change over time, or may vary depending on the particular asset or asset mix comprising the funds.

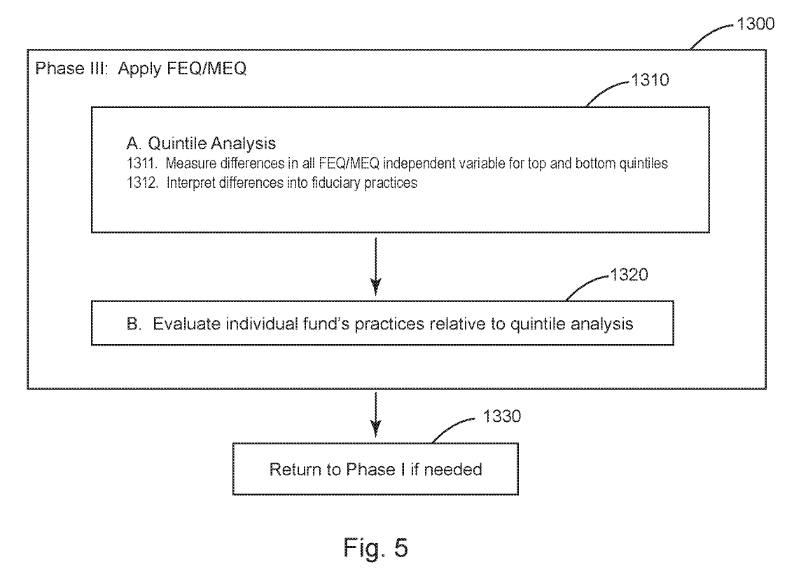

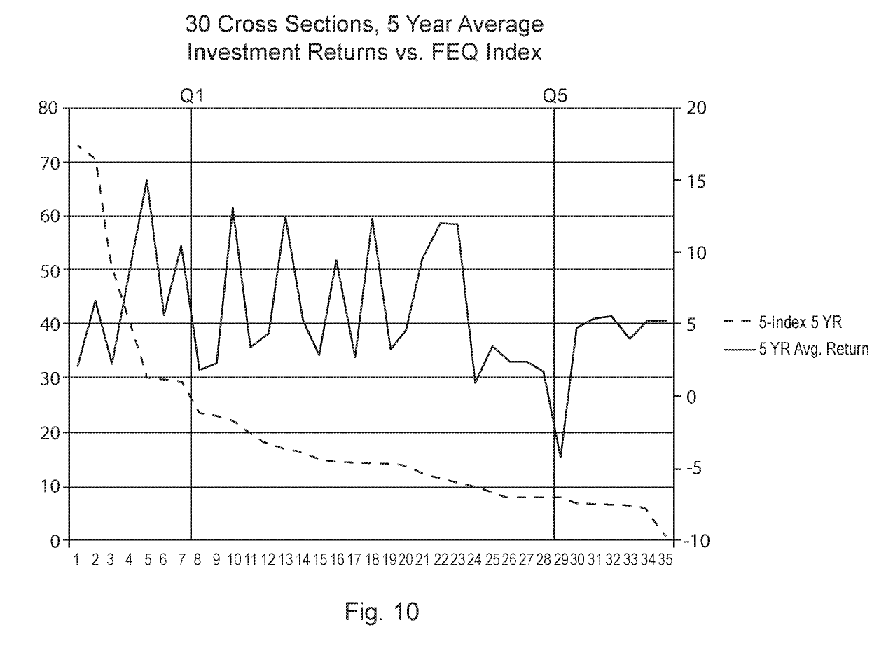

As discussed above, Phase 3 of the embodiment shown in FIG. 5 includes a quintile analysis of the applied FEQ or MEQ rating system. FIG. 10 depicts the FEQ data from 35 fiduciaries, corresponding to 35 funds, which were rated in accordance with the present disclosure. Specifically, the fiduciaries are plotted in descending order of FEQ rating from the first to the 35^{th} fiduciary, reflected as the dashed line in FIG. 10. In other words, the fiduciary with the highest FEQ (approximately 73) is shown first along the x-axis, descending down to the score of the 35^{th} position. From here, the boundaries of the 1^{st} and 5^{th} quintiles are marked with lines Q1 and Q5, respectively, depicting the funds with the top 20% and bottom 20% FEQ scores.

The present inventors have identified that by generating FEQ scores in accordance with the presently disclosed model, and further by segregating the fiduciaries into first and fifth quintile groups, differences in fiduciary behaviors and other variables can be ascertained between the top performing and bottom performing groups. However, the present disclosure anticipates other groupings and delimiting boundaries for separation to compare and contrast fiduciaries based on FEQ score, performance, and the collected variables in accordance with the presently disclosed systems and methods.

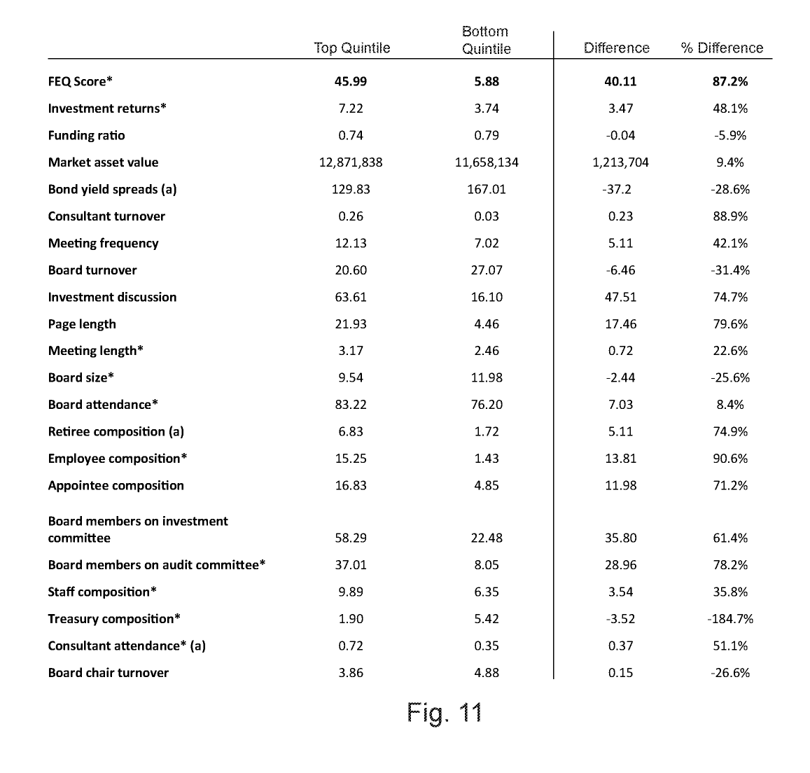

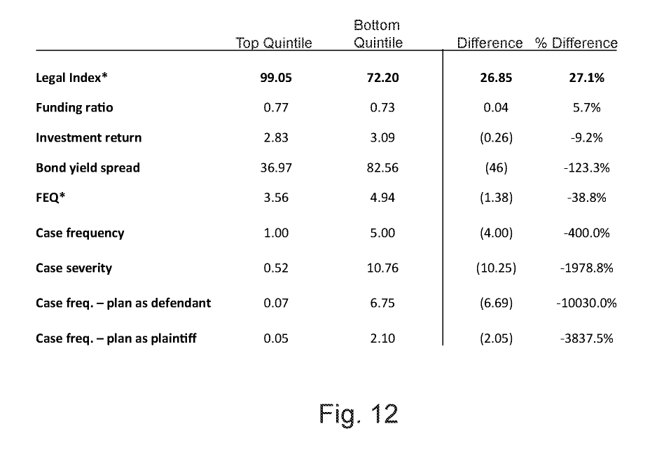

The results of an exemplary quintile analysis for comparison of 35 test funds are shown in FIGS. 11 and 12. Specifically, FIG. 11 depicts the FEQ scores as well as actual values for governance variables between funds in the top quintile and bottom quintile. Namely, the FEQ scores of funds between the top quintile and bottom quintile differ by 87%, also having a 48% difference in investment returns. In other words, the substantial difference in FEQ score provides explanatory value in identifying the funds having the greatest difference in investment returns. Likewise, FIG. 11 shows the differences between funds in the top quintile and bottom quintile for the legal index, whereby funds in the top quintile outperform funds in the bottom quintile by 27.1% in the present embodiment.

It should be recognized that while the foregoing largely discussed the legal index of legal event variables as a component of an FEQ or MEQ index, it may also or alternatively stand alone. For example, a legal index rating fiduciaries, or even non-fiduciaries (such as businesses, employers, service providers, or communities) would allow people to compare and contrast options from a legal perspective on an objective basis. In one embodiment, a prospective employee could compare employers by their respective legal index scores, either within an industry or against others of the same size, region, or the total population. Likewise, the index may assist in selecting an advisor, supplier or even celebrity spokesperson for protecting public image through association. The legal index rating may also be used for setting pricing of insurance plans for directors and officers, for example. In this regard, various embodiments of the legal index are useful for fiduciaries and/or non-fiduciaries.

Along these lines, the present inventors believe that there is a presently-unmet public interest in measuring the governance of public organizations who issue municipal bonds. Using the presently disclosed systems and methods, the inventors identified differences in bond yield spreads between organizations in the top and bottom quintiles of each index—25 bps (by FEQ) and 46 bps (by Legal Index), respectively. This is in contrast to systems and methods known in the art, which are driven by outliers and lack the ability to distinguish between top and bottom performers. It will be recognized that the FEQ/MEQ and/or Legal Index ratings would be equally applicable to corporate bonds as well, for example.

Additional detail is now provided regarding the specific steps and data sources used to generate the FEQ model and subsequent results shown in FIGS. 9a through 12.

In particular, these details are provided in the context of the exemplary process flow shown in FIG. 2.

Steps 100, 200, and 300 preferably include an interdisciplinary approach of identifying key factors that references the current literature across finance, law, organizational behavior (sociology and psychology) and ethics, which comprehensively informs the process of understanding and determining applicable categories and attributes. Since a tremendous number of factors can be gleaned from the wide variety of sources available, it is important to prioritize and select those that are likely to be most important. From there, data is obtained for each factor, which is then analyzed to determine which factors are significant. In certain embodiments, these factors can be generalized into four broad categories: Board Structure, Board Process, Human Factors and Decision-making. Likewise, there are at least four distinct theoretical approaches of examining public pension fund governance, which include: Political Economy, Organizational Design, Institutional, Empirical or “Corporate Governance.”

In the FEQ model and results shown in FIGS. 9a through 12, data was collected from a sample of 163 of the largest state and municipal pension systems from approximately 6,300 public retirement systems in the United States. This sample represents assets of over $1.4 trillion, or 47% of the population by assets. This dataset made available many of the financial and control variables as necessary inputs into the governance models developed and discussed herein. Data was examined from these plans over a five-year period, 2008-2012, which was selected to capture a market cycle.

This timeframe, of course, coincides with the Great Recession, the financial crisis that effectively began in 2008. While this may represent an extraordinary period in financial history, the present inventors believe using this period strengthens the power of the test for the present analysis because it permits examination of governance practices and their related effects under extreme conditions. In other words, it is likely that how organizations prepare, think, and act in advance and during times of crisis is critical to their performance during such periods.

As discussed above, one year forward returns reflecting that the governance process were used, having a one year lag based on analysis of the data. This one year lag was selected based on identifying a typical time delay after decisions made by fiduciaries to see a measurable impact. For example, the decision to change investment strategies, while having some immediate effect of course, requires time before it is has a quantifiable impact that is measurable in the data.

Once collection of the data was completed, cleansing was required to ensure there were no errors in the recorded observations, as discussed above. In addition to a manual review of the data, it also involved reviewing and analyzing the aggregate statistics for any abnormalities in the data including any unusual outliers. It should be recognized that while this step was provided manually, automated alternatives are also anticipated in practice.

Once the set of factors was determined, the next step was to identify the data sources to gather empirical data on each factor. Public pensions were initially selected as a primary organizational type for analysis, though the presently disclosed methods and systems would apply equally to private funds, corporate pension funds, trusts, and other assets. This reason for selecting this population was threefold. First, source data is readily available through public disclosures. Public organizations have more information publicly available, which include, for example, meeting minutes, agenda, and other memoranda that are in the public domain. Second, existing data sets are available e.g. the Boston College database, and other industry data. Finally, developing rating scores for fiduciaries of public pensions allows for immediate contribution to the debate within the public sphere around this topic.

Data was collected in two separate databases, one containing over 50 asset owner governance variables (the Governance Database), and one containing over 20 legal variables (the Legal Database). For the Governance database, data was collected from meeting minutes for every organization available online over the five year study period. For the legal database, data was collected from multiple legal database sources, including Bloomberg, Westlaw and Lexis Legal.

There are two ways to test whether the index is a useful measure, in terms of both absolute and relative effectiveness. An absolute measure is binomial in nature: either the organization was effective, or it was not. If the correct factors were identified, then the factors should be explanatory in nature. An absence of the critical factors could be indicative that the organization is bound for a fiduciary problem (e.g., underfunding, bankruptcy, litigation, etc.). A high FEQ, according to the theory, should translate into to a low ineffective score based on the two variables, case frequency and severity.

The second method of testing whether the grade is effective, on a relative, and as noted earlier, a lagged basis given the delayed effect of governance on performance outcomes observed in the data, i.e. fund returns, is a phenomenon that can be measured ongoing. These ongoing measures can indicate how well has the organization governed itself, and then in turn performed in its investment returns and other financial measures. Theoretically, the more critical governance factors that are satisfied, the better the investment performance.

With respect to absolute effectiveness, the first step in analyzing the data is determining whether effectiveness is conditionally present based on the combined variables. The FEQ as a rating and measurement system can only be useful if it, in fact, demonstrates some explanatory power. For this purpose, the Legal Index was also constructed to evaluate each organization. This is based on a reversed scale (to be consistent with the FEQ scaling). In general, 0-80 is ineffective and 80-100 is effective. These ranges were determined from what was observed in the data. Plans that fell below the critical value of 0.50 for a funding ratio consistently saw Legal Index measures below 80 on the index.

Legal case data was obtained and qualitative data scored to make quantitative data, which was used to formulate a qualitative framework for integrating the aggregate data set into a broader Asset Owner Governance model or rating model.

In this manner, the following equation was constructed:

FUNDR=f(FEQ,LI,X) Eq. 1:

In the above equation, FUNDR is the funding ratio of the pension, the best measure of overall effectiveness that addresses how the well funded the retirement plan is. The Legal Index (LI) variable is comprised of the frequency and severity variables. FEQ is the Fiduciary Effectiveness Quotient, and FEQ is defined by an index rating of (all or some portion) of the following factors: Structure, Process and People. Finally, X is defined as other control variables needed for the model.

An ineffective condition is defined as significant underfunded position, bankruptcy, significantly poor underperformance, criminal case, civil litigation, or significant board, committee or management reorganization. There could be any number to look at empirically to test the theory that if certain conditions are not met, then the probability of an organization being effective diminishes with each factor, as it will be known in retrospect whether the organization was effective. In this case, because no bankruptcies were included in the inventors' data set, the inventors focused on significantly underfunded plans by which the inventors define any plan with a funding ratio below 0.50 as significantly underfunded, and therefore ineffective.

As the inventors note above, there are two summary variables that the inventors have isolated to test for absolute effectiveness: 1) severity of an ineffective condition; 2) frequency of the ineffective condition.

To determine relative effectiveness, the inventors used performance data for the specified period of each organization in the inventors' sample. The inventors tested the validity of a hypothesis that the correct effectiveness factors had been identified. A composite rating was then examined as the independent variable and the investment performance outcome as the dependent variable. The composite rating was then used to assess the relationship between these metrics. The inventors tested the hypothesis that the governance factors, which determine fiduciary effectiveness, also impact return performance.

The following regression model was then created and tested:

R=f(FEQ,X) Eq. 2:

In the above equation, R is the investment return, and FEQ is the Fiduciary Effectiveness Quotient defined by an index rating of the following factors: Structure, human factors and process. X represents several other control factors that include size of the assets, types and proportions of the investments, investment expenses, and demographic and fiscal variables.

A priori, the present inventors expected there will be a linear relation between these two variables. Depending on the outcome of the research, when the inventors were successful in finding statistical support for this hypothesis, the inventors would have established an empirical link between fiduciary effectiveness and performance outcomes, and have a basis and methodology for quantitatively measuring, predicting, evaluating and comparing fiduciary effectiveness.

A model of relative effectiveness was created. Mathematically, fiduciary effectiveness may be reduced to this basic equation:

FE=G(S,Pr,P) Eq. 3:

### Where,

FE: Fiduciary Effectiveness

S: Board/Committee Structure

Pr: Process (or Engagement)

P: People

Consistent with corporate governance theory, the inventors narrowed the list of variables down to a set of 17 variables for the purpose of analysis for one embodiment of the presently disclosed systems and methods. Variables were analyzed in terms of their expected and estimated signs and related p-values, testing that the estimated coefficient does not equal zero. In general, governance variables will be proxies for the decision-making that occurs within the organization. Engagement variables such as attendance, meeting length, meeting minutes page length and meeting frequency convey information about how active and focused the board is. Structural variables, such as board turnover, use and attendance of the consultant and number of members likewise consider how the board is set up to interact and make decisions.

Using an ordinary least squares regression, the inventors reviewed seventeen governance factors in relation to investment returns. Nine out of 17 governance factors had consistent estimated signs with expected signs. The inventors initially expected the following factors would result in higher investment returns: 1) meeting length would indicate greater levels of focus and engagement; 2) more board members on the (a) audit and (b) investment committees would indicate deeper involvement; 3) more staff involvement would result in greater knowledge sharing; 4) less (a) board and (b) board chair turnover would mean greater continuity in governance; 5) fewer board members would be more effective, which would be consistent with other Corporate Governance findings; and 6) involvement by the consultant through attendance and participation would be helpful to the organization for their outside expertise and guidance.

The inventors also constructed “Investment Discussion” as a variable, which involved key word counts within the meeting minutes as a proxy for the type and substance of the discussion. These key words included “performance”, “watch”, “returns”, “on notice”, “alert”, “fees”, “risk”, “asset”, “allocation”, “pay to play”, and “adjust”, which denote ideas around investment concepts, decisions-points, and investment governance issues. While the expected signs did not match the estimated results found in the quintile analysis, they were consistent with the theory that more key words found in the documents were common among better governed, higher performing organizations.

These data are in addition to the data available to us from the Center for Retirement Research (CRR) at Boston College. CRR, in their Public Pension Plans database, which has a host of financial and actuarial data gleaned from public filings and disclosures. For the inventors' purpose, the inventors have incorporated a number of financial variables for analytical purposes, primarily to examine investment performance. In particular, the inventors have used three variables from this data set: 1) market assets, which represents the total asset value of the plan in nominal U.S. dollars; 2) investment returns, which are available on a rolling basis of 1, 5, and 10 years; and 3) the funding ratio, which is the market value of the assets in relation to the liabilities as measured by the actuarial Projected Benefit Obligation (PBO). The inventors have used the one-year investment returns to examine each plan's factors and related performance. The inventors have determined that a one-year forward relation exists, and therefore have incorporated the 1-year investment return as a leading dependent variable; returns essentially lag the fiduciary process by a year. The inventors have used market assets as a control variable for plan size.

In the case of investment expenses, the inventors' results were initially surprised on a couple of levels: 1) the inventors expected that this would be a detractor to returns, and the opposite relationship was indicated in the estimation; and 2) the estimated coefficient was not statistically significant. The reason why this was a surprising result is because the industry has become obsessed with investment expenses over the past several years, which has fed into a debate over “active” (higher cost, research-driven and actively-managed investments) versus “passive” (lower cost, index-defined) investments, and in this case the inventors found no such relationship to investment returns.

The inventors also incorporated asset allocation measures (equities, fixed income, real estate, alternative investments, and cash and cash equivalents) to account for the differences in types and proportions of investments. While governance decisions drive the investment process, investment returns are also influenced by decisions that occur at the investment manager level, so it is necessary to apply both sets of variables in examining the relationship to investment returns. In looking for proxies for state and municipal budgetary influences, as the well as demographics of the beneficiary population, the inventors used the actual annual contribution rates and total beneficiaries variables for each factor, respectively.

Total beneficiaries embody both “active members” or those still working, and “retired members”, those who are obviously in retirement and already receiving benefit payments. These will vary based on the distribution of the beneficiary population for each plan. In preliminary analysis, these additional variables were assigned to ascertain the formulation of five final models. The inventors applied the same set of primary and control variables in two of the models. The other models only required one or two primary variables in fitting a complete model, and based on the principle of parsimony, and using a “stepwise” approach to each model, the inventors used the fewest variables in each case to find the best “fit” for the model.

Finally, the inventors also examined the funding ratio as a dependent variable, consistent with the conceptual overview presented herein. To understand why all three dependent variables would be impacted by the FEQ in a similar way, one need only refer to the review the theory and chain of relationships within the U.S. Public Pension System. Governance is among the set of endogenous factors that affects investment returns. Investment returns impact the funding disparity and requirements of state and local governments, as measured by the funding ratio. The inventors also examined the relationship of pension risk to bond yield spreads to understand how the funding status and legal risk of the pension system impacts the bond yield spread of related general obligation municipal bonds.

A Legal Index was also created based on the following equation:

LI=H(CS,CF) Eq. 4:

### Where,

LI: Legal Index

CS: Case Severity

CF: Case Frequency

The inventors have developed a qualitative case severity framework, which has been further refined and expanded to incorporate the many varieties of cases encountered in this area of the law. These range from fraud on one extreme to minor statutory duties of plan operations on the other. These then were expanded to cover the following categories, in order of declining severity: investments-fraud; investments-breach of fiduciary duty/contract; benefit management/disbursement; plan operations; minor statutory duties concerning operations; ulterior investment concerns; and undefined.

Exemplary statistical processes and tests used throughout the development and application of the systems and methods are disclosed herein. However, it should be recognized that alternative statistical processes, tests, and orders of application are also anticipated herein. When working with unbalanced panel data with a large number of regressors (such as the 17 governance factors discussed above), but with a limited time series (five years of annual periods), there are a number of steps that were taken to ensure the model was correctly specified to handle the potential cross-section effects. As the inventors noted earlier, an unbalanced panel is one where there are missing observations, in this case due to the inconsistency of reporting by the public pensions both in points of time of when they report and what they report. Because their meeting minutes are obviously determined by when the boards meet—and every organization maintains their own meeting schedule, which, of course, varies by organization—this created an unbalanced panel sample. Additionally, there were some years when minutes for a number of plans were not available.

The inventors first undertook an ordinary least squares regression to begin examining the data. The inventors applied the Hausman test to test whether the model is subject to fixed, or random, effects. In the immediate case, it was clear that the model would be subject to fixed effects when running the comparison test. The Chi-squared statistic had a p-value of 0.0000, which required strongly rejecting the null hypothesis that the model was subject to random effects. The inventors also checked for redundancy among the instrumental variables by applying the fixed effects redundancy test, and again the cross-section F and Chi-squared statistics both had p-values of 0.0000, strongly supporting non-redundancy of fixed effects among cross sections. This is important because the inventors did not want to subject the model to omitted variable bias.

Next, a White diagonal co-efficient covariation method was applied to correct for heteroscedasticity, which is a common problem with panel data. This did not, however, address the issue of multicollinearity one encounters when applying a large number of regressors within a multivariate equation.

Principal Components Analysis (PCA or Factor Analysis) is one method for addressing multicollinearity among regressors. A data reduction technique, it seeks to explain observable phenomena with a fewer number of variables. By reducing the number of variables to their “principle components”, the essential statistical properties are preserved, without the repetitive and potentially distortive effects of multicollinearity (i.e., sign reversal or over-estimated standard errors.) It also has the additional benefit of making possible the summarization of factors to a manageable index term, which can then be applied to comparative peer group analysis (i.e., through separation of economic units into quintiles), which was one goal of the research. One drawback to the use of the PCA method is that, in general, regressors can bias the results. In the present case, Principal Component Extraction was conducted based on an Eigenvalue of 1 or greater and the PCA factor loadings and interpretation of the components.

The inventors analyzed the seventeen governance variables using these PCA. This generated 17 factor loadings. The inventors applied the Kaiser Criterion to extract the Eigenvectors. In this embodiment, the inventors determined the principal component factor selection by eliminating any factor with an Eigenvalue less than 1. This generated six components that captured 69% of the total variance of all 17 variables. Once the inventors had these factor loadings, they were able to combine the loadings with each variable, and then apply PCA-determined weights to each new factor. This was done after applying a Varimax rotation. Any individual factor that had an Eigenvector of 0.20 or greater was considered as containing meaningful, relevant information for the principal component and helped in the interpretation. The principal components of the present embodiment are summarized here:
Professionalism—This principal component may be interpreted as the level of professionalism within the organization. It is comprised of consultant attendance, meeting duration, page length of the minutes, board participation on the audit committee, employee composition, board participation on the investment committee and investment discussion.
Board Composition—This principal component may be interpreted as the composition and capacity of those serving on the board. It is comprised of appointee composition, employee composition, board attendance and retiree composition.
Engagement—This principal component may be interpreted as the degree of engagement by the board members, staff and consultant. It is comprised of consultant attendance, staff composition, board attendance and board chair turnover.
Staff—This principal component may be interpreted as the extent of involvement by professional staff. It is comprised of staff composition and treasury composition.
Institutional Knowledge—This principal component may be interpreted as the continuity within the organization of its institutional knowledge. It is comprised of appointee composition, board turnover, board size, and consultant turnover.
Diligence—This principal component may be interpreted by the extent of the diligence and thoroughness of the organization in exercising its governance process. It is comprised of consultant attendance, page length of meeting minutes, treasury composition and investment discussion.

The weighted combination of these principal components ultimately constituted the index for each plan and year for a total of 35 Plans and 113 observations. Each variable was standardized prior to combination. Once the variables were reduced to a single index, the inventors could then normalize or scale the index to reinterpret the index values on a scale of 0-100. This final step allowed the ranking and segmentation of cross-sections into quintile groupings for further analysis and comparison.

Now that the inventors had a single standardized index measure, it was time to re-estimate the inventors' regression model with the specifications outlined above using the following equation:

R(Y)_{citi+1}=C+B₁FEQ(X₁)_{citi}+B₂MVA(X₂)_{citi}+B₃Eq(X₃)_{citi}+B₄Fx(X₄)_{citi}+B₅Re(X₅)_{citi}+B₆A(X₆)_{citi}+B₇CCE(X₇)_{citi}+B₈IE(X₈)_{citi}+B₉BN(X₉)_{citi}+B₁₀RC(X₁₀)_{citi}+μ Eq. 5:

### Where,

Rₜᵢ₊₁: One year forward investment return

C: Constant

FEQ: Fiduciary Effectiveness Index (FEQ)

MVA: Market Asset Value

Eq: Equity allocation

Fx: Fixed income allocation

Re: Real estate allocation

A: Alternative investment allocation

CCE: Cash and cash equivalent allocation

IE: Investment expenses

BN: Total beneficiaries

RC: Required contribution rate

ci: Cross-section (Plan)

ti: Time period (Annual)

μ: Random error term

The dependent variable was the one-year forward return to allow for a one-year lag in the regressor. As discussed above, this reflects the point that fiduciary activities do not immediately have an impact (e.g., managers are hired and fired over time, allocations may change periodically, etc.) Also, to fill out the inventors' model, the inclusion of some additional demographic, actuarial and financial factors reduced the number of common cross-sections to 31.

The control variables chosen for the model were selected to capture additional effects that also determine or impact investment returns. Market asset value, or plan size, represents the total assets in the plan. The size of the plan may impact the types of investments available to the plan or the direction of those investments. Asset allocation percentages related to equities, fixed income, real estate and alternatives were also chosen since differences in asset allocation can have a large impact on investment returns. The inventors also incorporated investment expenses, which some believe to be a key driver of investment return. The inventors also selected total beneficiaries and required contribution rates, two actuarial variables, to capture differences in plan populations and funding requirements, which the inventors considered also potentially influential in investment decision-making.

With the exception of investment expenses and required contribution rate, every coefficient estimate associated with the regressor was identified to be statistically significant below the 3% level using a one-tail test for the primary variable (FEQ) and a two-tail test for the control variables. The model based on the F-Statistic was statistically significant below the 1% level. This combination of factors explains 69% of the variation in one-year forward returns (R-squared). The expected and estimated signs for the FEQ were consistent; an increase in the FEQ is related to an increase in returns. The FEQ coefficient may be interpreted as follows: A one-unit change in the index is associated with a 0.36% change in investment return when all other variables are held constant.

Having demonstrated statistical evidence of a relationship of the FEQ with investment performance, the inventors turned to the other dependent variables to continue the inventors' exploration of the potential far-reaching impact of fiduciary effectiveness. The next model examines the relationship between the FEQ and bond yield spreads.

Beginning with the inventors' focal variable (the FEQ, a summary of 17 governance variables in the present embodiment), it was not necessary to use control variables in this case. In other words, the inventors were able to explain most of the variation in the dependent variable with the FEQ index alone.

The regression equation was used as follows:

BY(Y)_{citi}=C+B₁FEQ(X₁)_{citi}+μ Eq. 6:

### Where,

BY: Bond Yield Spread

C: Constant

FEQ: Fiduciary Effectiveness Index (FEQ)

ci: Cross-section (Plan)

ti: Time period (Annual)

μ: Random error term

The inventors were initially expecting an inverse relationship (i.e., a one-unit increase in the FEQ would mean a commensurate decrease in the bond yield spread). However, the sign was identified as being positive. In other words, the expectation was initially that better governance would translate into lower yield spreads. Here this was not to be the case, yet in the inventors' quintile analysis described both above and in additional detail below, the inventors did find such differences among the groupings. However, the differences were somewhat inconsistently across peer groups, which may be due to a couple of factors. First, the inventors had limited data availability for this analysis, and secondly, as noted earlier, investors during the study period were not as attune to pension risk, which came after especially starting in early 2013. Therefore, the inventors determined that there is strong evidence of a relationship, though the direction of that relationship was not consistent either in the available data, during the study period, or both.

Further summarizing the model estimation, the FEQ coefficient was interpreted as follows: A one-unit change in the index is associated with a 5.6 basis point change in the bond yield spread. Bond yield spreads are measured in basis points (i.e. 1%=100 basis points or bps).

The final model under relative effectiveness examined the relationship between the FEQ and the funding ratio. Here the inventors had no data limitation and made use of the complete sample of 35 cross-sections:

FR(Y)_{citi}=C+B₁FEQ(X₁)_{citi}+μ Eq. 7:

### Where,

FR: Funding Ratio (FUNDR)

C: Constant

FEQ: Fiduciary Effectiveness Index (FEQ)

ci: Cross-section (plan)

ti: Time period (annual)

μ: Random error term

The inventors further developed a second model based on the absolute effectiveness of selected variables. The inventors collected case information during the study period on available legal and regulatory case for almost every plan included in the Boston College database, regardless of whether the plan is noted in the case as the defendant or plaintiff. Using these data, the inventors have constructed four variables for examination relative to fiduciary effectiveness: case severity; total case frequency; defendant case frequency; and plaintiff case frequency. Two main factors were anticipated to be indicators of how severe a system may be under financial and ultimately legal stress: 1) how often cases occur, and 2) the quality of the cases involved. The inclusion of the defendant and plaintiff variables help distinguish between “good” legal activity, where the board is diligently protecting its rights versus “bad” legal activity, where the questions of fairness and equity keep recurring—and potentially growing—between stakeholders and the plan.

The inventors also subjected the four legal variables to PCA. This generated 2 factor loadings, to which a Scree Plot was applied to extract the Eigenvectors. Specifically, the principal component factor selection was completed by eliminating any factor that appeared to contain less information (i.e. percentage variance) based on the Scree Plot. This generated two factors that captured 83% of the total variance of all 4 variables. Once the inventors had the factor loadings, they combined the loadings with each variable, and then apply PCA-determined weights to each new factor. The inventors used a minimum Eigenvector of 0.40 to aid in interpreting each component.

The weighted combination of these factors ultimately comprised the index. Each variable was standardized prior to combination. Once the variables were reduced to a single index, the index was then normalized to reinterpret the index values on a scale of 0-100. In certain cases it was necessary to reverse the index (subtract each measure from 100) to make consistent with the FEQ measure (i.e., 0 worst, 100 best). This allowed the ranking and segmentation of cross-sections into quintile groupings for further analysis and comparison.

Using the same specification and tests for this unbalanced panel regression, the inventors developed the following regression models. Again, the panel was unbalanced because not every observation was available for all plans as described in the earlier section. Legal case data was also uniquely varied in that states report legal cases inconsistently as well. When considering the most relevant variable for measuring the health of the overall plan, which could be affected by governance issues, financial and legal problems, or all three, the funding ratio was selected as the dependent variable. The first model is an extension of the model that considered the FEQ as the only regressor. Now, taking both the Legal Index and the fiduciary effectiveness index as the regressors, the inventors constructed the following equation:

FUNDR(Y)_{citi}=C+B₁LI_{citi}+B₂FEQ(X₁)_{citi}+μ Eq. 8:

### Where,

FUNDR: Funding Ratio

C: Constant

LI: Legal Index

FEQ: Fiduciary Effectiveness Index

ci: Cross-section (Plan)

ti: Time period (Annual)

μ: Random error term

While the addition of the Legal Index did not impact the overall fit of the model from the original regression model (i.e., small increase in the adjusted R-Square and slight decrease in the F-Statistic), the inventors did determine that the estimated coefficient on the Legal Index is statistically significant at below the 3% level, and the FEQ is significant at below the 1% level. The overall model is significant below the 1% level. As such, this combination of factors explains 93% of the variation in the funding ratio (R-squared). The expected and estimated signs for the Legal Index were consistent, and as noted earlier, remain inconsistent for the FEQ. The model results may be interpreted as follows: A one-unit change in the Legal Index is associated with a 0.000971 change in the funding ratio when the FEQ is held constant.

The inventors then tested the model in being able to differentiate effectiveness on an absolute basis. Since there were no cases of bankruptcy in the sample, the inventors instead established an absolute ineffectiveness criterion of 50% funded or below for any plan.

The inventors constructed a binomial dependent variable for a probit model based on the funding ratio. Every variable above 0.50 was assigned a one and anything equal to or below, a zero. The purpose of the model is to estimate the probability that an observation with particular characteristics will fall into one of two categories, in this case a plan deemed effective or ineffective. The value of 0 indicates the plan is underfunded and ineffective, and the value of 1 indicates the plan is effective. This model allows us to examine the related conditions that are causally determining absolute ineffectiveness (i.e., poor governance, underperforming investments, inadequate contributions, etc).

Whereas, the continuous variable of financial performance provides a comparative snapshot of the pension fund from which the inventors can examine a trend that may improve or worsen, the failure mode of the absolute condition gives a measure of failure that is both deeper and more intractable.

The probit model is most often estimated using the standard maximum likelihood procedure. While a probit binary response model is helpful for probability estimation and categorization, the coefficients themselves are not related in a linear fashion with the probabilities. This means coefficient estimates do not give the marginal impact of a change in the attribute on the probability of the dependent variable, and the inventors cannot easily interpret the marginal impact of an independent variable on probability. The marginal impact is not only a function of the coefficient estimates, but of the value or size of independent variable as the well. One final note, the inventors used White's method for heteroscedasticity correction just as with the prior models.

With this as background, the following regression equation was developed, using the probit method for the model testing absolute effectiveness:

Pr(FUNDR(1,0)_{citi}=C+B₁FEQ(X₁)_{citi}+B₂LI(X₂)_{citi}+B₃MVA(X₃)_{citi}+B₄Eq(X₄)_{citi}+B₅Fx(X₅)_{citi}+B₆Re(X₆)_{citi}+B₇A(X₇)_{citi}+B₈CCE(X₈)_{citi}+μ Eq. 9:

### Where,

P(FUNDR(1,0): Probability of the funding ratio being above or below 0.50

C: Constant

FEQ: Fiduciary Effectiveness Index (FEQ)

LI: Legal Index

MVA: Market Asset Value

Eq: Equity allocation

Fx: Fixed income allocation

Re: Real estate allocation

A: Alternative investment allocation

CCE: Cash and cash equivalent allocation

BN: Total beneficiaries

RC: Required contribution rate

ci: Cross-section (Plan)

ti: Time period (Annual)

μ: Random error term

The estimated coefficient on the FEQ was determined to be significant below the 1% level. Market Asset Value, Allocation to Real Estate and Allocation to Cash also have statistically significant coefficient estimates at the 5% level or below. Including the Legal Index did improve the overall fit of the model by increasing both the pseudo-R squared and reducing the Likelihood Ratio statistic. The overall model was statistically significant below the 1% level based on the probability of the Likelihood Ratio test statistic. The McFadden pseudo R-squared is modestly high at 0.51. To help interpret these results, an Expectation-Prediction Evaluation for Binary Specification was performed using 0.5 as the cutoff. The model demonstrates a 93% success rate in correctly estimating the binomial measure of effectiveness.

Next a quintile breakdown of the legal factors was conducted factor by factor. The fiduciary effectiveness of boards and committees charged with managing investment pools can be measured both on a relative and absolute basis as discussed above. The inventors' examination of the meeting minutes data of 35 public pension plans generated sufficient information over a five-year period to ascertain 17 governance factors. When subjected to Principle Components Analysis, a data reduction technique, the inventors produced a standardized index measure, the Fiduciary Effectiveness Quotient (FEQ). When combined with other financial and demographic variables, the inventors were able to construct a model that explained a large percentage of the variation in investment return performance. As a standalone measure, the explanatory power of the index was even greater when applied to municipal bond yields and the funding ratio.

Turning to a measure of absolute effectiveness, the inventors' collection of legal case data over the study period for 153 plans yielded two variables of interest: case severity and case frequency. Case severity is based on a qualitative assessment of each case type across 20 categories. Case frequency is simply a measure of how often the cases occur for each plan. The inventors found evidence of a statistical relationship between the funding ratio when regressing it against the Legal Index and the fiduciary effectiveness measure. When applying a probit model, the inventors the were able to identify with 93% accuracy based on a similar grouping of independent variables found in the inventors' first model including both the FEQ and Legal Index, whether a plan was likely to be deemed effective or ineffective based on a minimum funding ratio criterion of 0.50.

The foregoing was then used to address the very simple question, “how do I (i.e., beneficiaries, taxpayers, bond holders, stock holders, issuers, etc.) know that my money is being managed effectively by an organization whose members I do not know and over whom the I have little or no control?” Unlike a company which is subject to the change of control market, where a buyer (or a creditor) will come in and take over a poorly run company, a poorly run pension plan has no such corrective mechanism other than bankruptcy, or municipal bond market pressure.

There were several major findings in the development and application of the presently disclosed systems and methods. Boards and other fiduciaries of top quintile plans, when compared to bottom quintile plans, display the following governance characteristics: 1) Have a higher FEQ Score (87% higher), 2) Meet more often (42% more), 3) Meet longer (23% longer), 4) Turnover their membership less frequently (31% less), 5) Have more substantive discussions (75% higher), 6) Have fewer board members (26% fewer), 7) Have greater attendance (8% more), 8) Have higher participation on investment and audit committees (61% and 78%, respectively), 9) Have their consultant present (51% more), 10) Turnover their board leadership less (26% less), 11) Have more staff participation in meetings (36% more), 12) Have more appointed than elected members (71% more), 13) Tend to be larger plans (9% larger), 14) Have 48% higher returns long-term, and 15) Have 27% less interest cost on related municipal bonds.

As discussed above, the inventors also identified the unexpected result that investment expenses had no statistical significance in relation to investment returns in the first regression model that looked at investment returns in relation to the FEQ and other variables for 35 plans in the inventors' sample set. This discovery is of particular interest because it calls into question the current emphasis in the industry on reducing investment expenses. In actuality, the industry sentiment appears to be an over-emphasis on reducing investment expenses, which may actually harm pension plan performance. Large pension systems that use low-expense strategies, such as the state of Nevada, did not score particularly the well on the FEQ, having average to below average returns, and average to below average funding ratios.

With respect to legal characteristics, top quintile plans, when compared to bottom quintile plans, were also determined by the inventors to: 1) Have a higher Legal Index score (27% higher), 2) Have much fewer legal cases (5× less), and fewer frivolous cases (20× less), 3) Be named defendants less (96× less), 4) Pursue litigation less as plaintiffs (42× less), 5) Be 5.7% better funded, and 6) Have less than half of the bond interest cost on related municipal bonds.

Further embodiments of the present disclosure relate to specific areas of interest within governance. For example, the systems and methods described above may incorporate data relating to Environmental, Social, and Governance (ESG) factors. Below is a brief background on ESG, challenges identified by the present inventors relating to ESG within the systems and methods currently known in the market, and a list of exemplary ESG factors. Through experimentation and development, the present inventors have identified that, as with governance more generally, no systems or methods known in the market provide meaningful ratings for the fiduciaries with respect to ESG factors, and particularly with respect to the corresponding impacts on financial performance. It should be recognized that assessing non-financial impacts is also anticipated by the present disclosure, including the impact of issuing bonds for charter schools on student test scores or literacy rates, for example.

As previously discussed, these factors may be utilized for rating the performance of particular companies, municipalities or organizations, funds, and the like. Likewise, “fiduciary” is used to broadly describe the individuals and/or entities involved in governing such companies, municipalities, organizations, funds, and the like, including through assessment of the mechanisms implemented by, and/or behaviors of, such fiduciaries.

In the early years of the new millennium, the major part of the investment market still accepted the historical assumption that ethically directed investments were by their nature likely to reduce financial return. Philanthropy was not known to be a highly profitable business and Milton Friedman provided a widely accepted basis that the costs of behaving in an ethically responsible manner would exceed the benefits. However the assumptions have since been fundamentally challenged.

Early efforts began with Robert Levering and Milton Moskowitz's listing of the Fortune 100 Best Companies to Work For, which considered corporate social responsibility and how financial performance fared as a result. Of the three areas of concern that ESG represented, the environmental and social had received most of the public and media attention, based in part on growing fears concerning climate change. In other words, this brought the spotlight onto the corporate governance aspect of responsible investment. The analysis concerned how the companies were managed, what the stockholder relationships were, and how the employees were treated. Moskowitz argued that improving corporate governance procedures did not damage financial performance, but in contrast maximised productivity, ensured corporate efficiency, and led to the sourcing and utilizing of superior management talents.

In 2011, Alex Edmans, a finance professor at Wharton, published a paper in the Journal of Financial Economics showing that the 100 Best Companies to Work For outperformed their peers in terms of stock returns by 2-3% a year over 1984-2009, and delivered earnings that systematically exceeded analyst expectations.

During this same period, the United Nations Environment Programme Finance Initiative in 2005 commissioned a report from the international law firm Freshfields Bruckhaus Deringer on the interpretation of the law with respect to investors and ESG issues. The Freshfields report concluded that not only was it permissible for investment companies to integrate ESG issues into investment analysis but it was arguably part of their fiduciary duty to do so. In 2014, the Law Commission (England and Wales) confirmed that there was no bar on pension trustees and others from taking account of ESG factors when making investment decisions.

Where Friedman had provided the academic support for the argument that the integration of ESG type factors into financial practice would reduce financial performance, numerous reports began to appear in the early years of the century which provided research that supported arguments to the contrary. In 2006 Oxford University's Michael Barnett and New York University's Robert Salomon published an influential study which concluded that the two sides of the argument might even be complementary—they propounded a curvilinear relationship between social responsibility and financial performance, both selective investment practices and non-selective could maximize financial performance of an investment portfolio, the only route likely to damage performance was a middle way of selective investment. Besides the large investment companies and banks taking an interest in matters ESG, an array of investment companies specifically dealing with responsible investment and ESG based portfolios began to spring up throughout the financial world.

Many in the investment industry believe the development of ESG factors as considerations in investment analysis to be inevitable. The evidence toward a relationship between consideration for ESG issues and financial performance is becoming greater and the combination of fiduciary duty and a wide recognition of the necessity of the sustainability of investments in the long term has meant that environmental social and corporate governance concerns are now becoming increasingly important in the investment market. ESG has become less a question of philanthropy than practicality.

There has been uncertainty and debate as to what to call the inclusion of intangible factors relating to the sustainability and ethical impact of investments. Names have ranged from the early use of buzz words such as “green” and “eco”, to the wide array of possible descriptions for the types of investment analysis—“responsible investment”, “socially responsible investment” (SRI), “ethical”, “extra-financial”, “long horizon investment” (LHI), “enhanced business”, “corporate health”, “non-traditional”, and others. But the predominance of the term ESG has now become fairly widely accepted. A survey of 350 global investment professionals conducted by AXA Investment Managers and AQ Research in 2008 concluded the vast majority of professionals preferred the term ESG to describe such data.

Interest in ESG and sustainable investing runs strong for plan participants, according to Natixis' 2016 Survey of Defined Contribution Plan Participants. In fact, more than six in ten participants agreed they would be more likely to contribute or increase their contributions to their retirement plan if they knew their investments were doing social good.

In January 2016, the PRI, UNEP FI and The Generation Foundation launched a three year project to end the debate on whether fiduciary duty is a legitimate barrier to the integration of environmental, social and governance issues in investment practice and decision-making.

This follows the publication in September 2015 of Fiduciary Duty in the 21st Century by the PRI, UNEP FI, UNEP Inquiry and UN Global Compact. The report concluded that “Failing to consider all long-term investment value drivers, including ESG issues, is a failure of fiduciary duty”. It also acknowledged that despite significant progress, many investors have yet to fully integrate ESG issues into their investment decision-making processes.

Despite the rapid growth of ESG funds across several measures, the present inventors have identified four main obstacles to the market today. The first obstacle, which relates to definitions and standards, presents a high challenge. A survey recently conducted by McKinsey found that 59% of institutional investors, already implementing some form of ESG strategy in their portfolios, were struggling with clarity around standards and terminology, that shows some degree of confusion on the subject.

For example, MSCI scores Exxon an A− with low controversy scores, compared to peers a relatively good ESG score. It becomes difficult to decide how to make such a comparison, whether certain sectors, such as oil producers, should even be included in comparative ratings, and the like.

Another criticism is directed at the ratings firms themselves regarding the inconsistency of ratings. These ratings are often not the same, or even similar, for a given issuer. For example, FTSE gives Warren Buffett's Berkshire Hathaway BRK.B the lowest score of any member of the S&P 500, while MSCI gives it a BB, the bottom end of its “average” category. Comcast CMCSA is the other way around, scoring 4.4 out of five at FTSE, but rating only B, or “laggard,” from MSCI. Consequently, the empirical argument on better risk-adjusted performance is untenable if one cannot even rely on predictable, consistent standards for a given issuer. If a fiduciary's interpretation of the data leads them to use MSCI's rating, rather than Sustainalytics' rating (for example) or vice versa, and that trade leads to inferior portfolio performance, the subsequent response is unclear. In short, it is very challenging to meet the fiduciary obligation to maximize performance, recognizing that superior ESG practices drive better returns, when ESG ratings lack standards and are thus inconsistent.

Standards and reporting are catching up through the good work of organizations like the Sustainable Accounting Standards Board (SASB). Their final set of recommendations is due out in August of 2018. Likewise, the launch of the Morningstar Sustainability Rating was a positive development in late 2016 for fund analysis. However, the present inventors have identified that the role of values expression in ESG investing needs to be better understood, and the gray areas clarified, in relation to SRI principles. For example, it must be clear whether ESG-minded inventing is focused on better performance, impact, or both. Likewise, the systems and methods known in the art suffer from a lack of differentiation between ESG managers and the standards for reporting performance (and ESG behaviors) to investors.

In conjunction with these improved standards, the systems and methods of the present disclosure provide for consistent ratings of fiduciaries with respect to governance, including ESG factors in particular.

Another challenge is with adoption of ESG, including awareness and understanding its role and how it is different from SRI or even Impact Investing. There has been some discussion, particularly with faith-based organizations, on explaining the differences. However, not enough investors, especially retail investors, are jumping in.

The present inventors have identified this trend to be less demand driven, and more supply driven. Moreover, through investigation, the present inventors have demonstrated how ESG can be an integral component on the asset management side of the business to mitigate risk, as well as to drive higher returns. As asset managers better understand ESG as a core investment process item, the notion of a separate ESG product, different from other active or indexed products starts to diminish. In time, ESG considerations will become the way investing is done, and theoretically should affect all manner of investing. The problem today is that too many fiduciaries are claiming to be ESG managers without any standards of practice attached to that. The systems and methods provided in the present disclosure provide consistency across assets, allowing investors and the like to better discern which fiduciaries truly focus on ESG factors within asset governance, and which simply apply buzzwords to capitalize on labeling themselves as being ESG-minded or green.

A third challenge relates to the quality and availability of the underlying information itself. Specifically, the present inventors have identified that there is a need for more information, better issuer disclosure, and better quality information providing practical insight. Some institutions, such as the Global Reporting Initiative (GRI), Governance and Accountability Institute and SASB, are beginning to collect such information. However, this has created another problem, which is of having too much information for fiduciaries and investors to manage. The present inventors have identified that relevant governance factors can run to 150 variables or more, making it very challenging to distill down to meaningful data. In contrast to the systems and methods known in the art, those presently disclosed allow the most important of these variables to be modeled within a single index. As an investment manager, client, or investment board looking at a report, such a single index measure is necessary for an informed and accurate comparison.

Yet another is the application of ESG factors outside the context of public markets. As was reported in the Wall Street Journal recently, new issuances within the private markets have eclipsed the public markets for the last six years in a row. The number of publicly traded companies is now less than half compared to two decades ago. The question becomes how this work relating to the impacts of ESG minded governance can also be applied in the private markets (e.g., private equity). Specifically, public markets offer the benefit of providing information through ongoing disclosure requirements, which is also a reason many companies no longer want to remain public. Similarly, systems and methods known in the art have not adequately addressed such assets as municipal bonds and the like. One of the constraints on the growth of ESG among municipal ETFs has been the lack of data available to the exchanges. In light of this, governments need to be held to the same standards, especially in light of the rapid growth in green bonds, recent tax legislation around Opportunity Zones, and the emergence of Social Impact Bonds. This may be best driven by a combination of participation by issuers, investors, intermediaries and standard-setting organizations, just as in the public side of ESG.

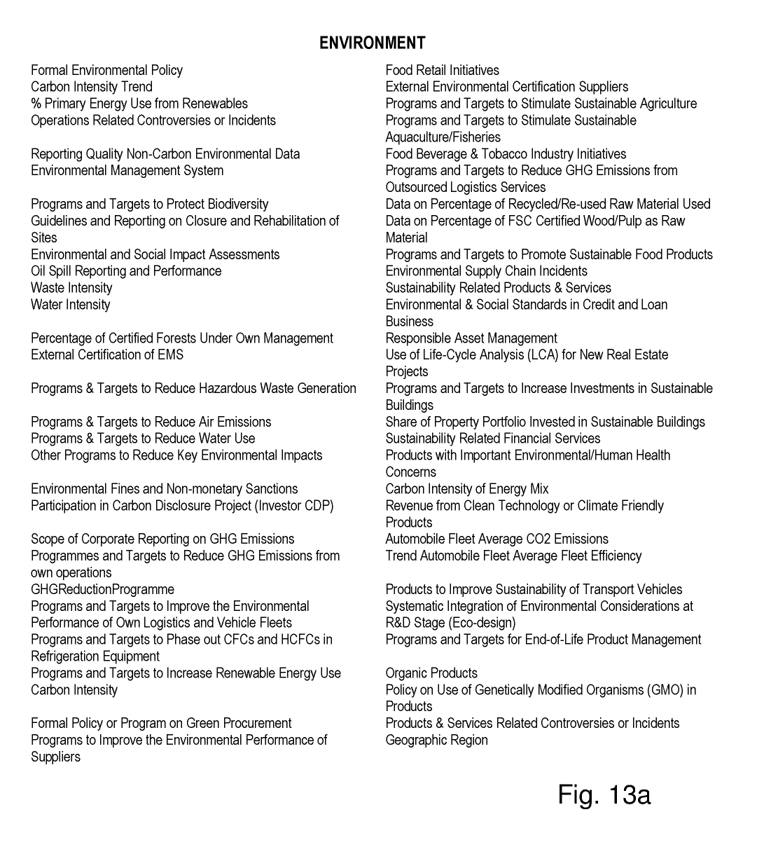

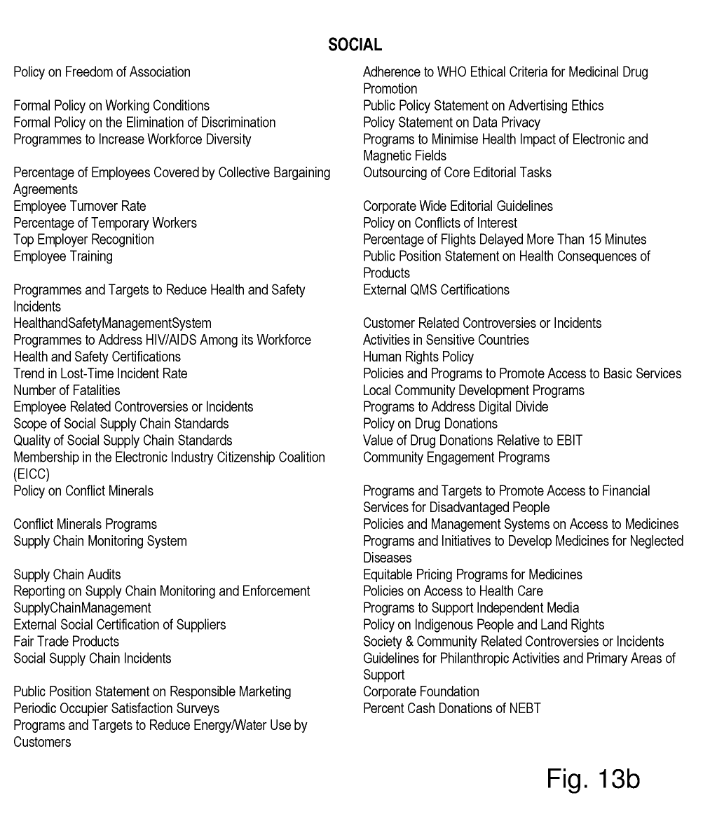

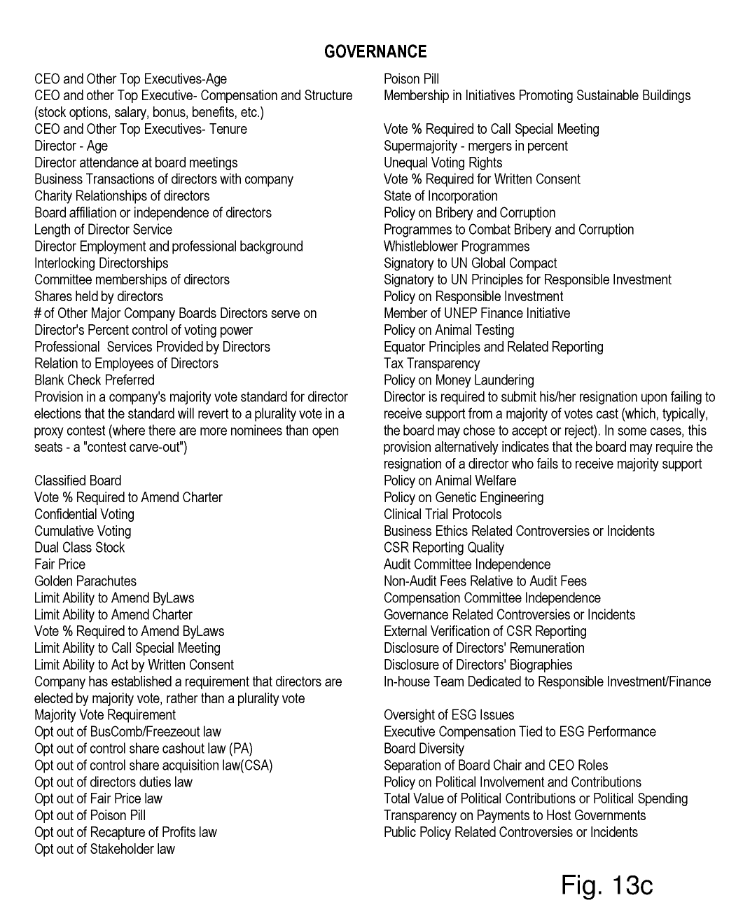

Through this additional information, the presently disclosed systems and methods provide for rating of fiduciaries that govern assets, whether public, private, municipal, and the like. In addition to the data sources provided in FIGS. 6a-6b for governance generally, FIGS. 13a-c depict exemplary variables relating to Environmental, Social, and Governance (ESG) factors. FIGS. 13a-c also depict exemplary categorization for variables, such as employing programs and targets for reducing air emissions or water usage within “environmental” concerns, and rates of employee turnover within “social” concerns.

It should be recognized that these categories are merely exemplary, which may be subdivided, added to, or recombined in alternative manners. Likewise, the listed subsets of data within a category are merely examples. For example, additional data may relate to concerns or opportunities in nuclear energy, human rights, consumer protection, and/or animal welfare.

In certain alternative embodiments, such as those for rating municipalities as fiduciaries, top level categories may be governance/fiscal issues, public safety (including crime rates), education (including literacy rates, graduation rates, etc), diversity, poverty (including income disparity, the percentage at or below the poverty line), heath metrics (including access to healthcare, percentages of insured, percentages of people receiving assistance), and environmental factors (including air quality, industrial sites and illegal waste dumping, mercury exposure, water safety, mass transit, food “deserts” or access to affordable and nutritious food, green space, lead poisoning, climate change and basic living, and heat exposure).

It should further be recognized that, like factors for governance more generally as discussed above, this data may be provided from a wide variety of sources. In the context of ESG factors, MSCI, Sustainalytics, and others may provide relevant data used in the presently disclosed systems and methods.

In further embodiments according to the present disclosure, additional data-mining tools are anticipated for providing data for modeling. For example, rather than providing known keywords to search within the meeting minutes of a particular organization (discussed above), additional tools may be used to instead identify the keywords or patterns of highly-rated fiduciaries. This ensures that models remain current with the times, and also provides for further learning of the system as a whole. Such a pattern engine will also help identify new areas of focus as new problems, injustices, and opportunities arise in the future.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

We claim:

1. A method for rating fiduciaries that govern assets, the method comprising:
collecting governance variables relating to at least one of environmental and social factors for governing the assets, wherein the governance variables impact performance for the assets;
assigning control variables, wherein the control variables also impact the performance for the assets;
compiling a collection of actual test values for the governance variables, the control variables, and the performance for test assets within the assets;
assigning a weight factor indicating the impacts on the performance for the test assets by each of the governance variables and the control variables;
constructing a rating model incorporating the governance variables and the control variables with each respective weight factor; and
collecting actual asset values for the governance variables and the control variables for a given asset within the assets; and
rating a given fiduciary within the fiduciaries that governs the given asset by using the rating model with the actual asset values collected.

2. The method according to claim 1, wherein the assets include municipal bonds.

3. The method according to claim 1, wherein the governance variables include keyword occurrences in meeting minutes of fiduciaries.

4. The method according to claim 1, wherein the collection of the actual test values includes data relating to environmental impact.

5. The method according to claim 4, wherein the data relating to environmental impact includes a percentage of energy use from renewable energy sources.

6. The method according to claim 1, wherein the governance variables include independent variables and dependent variables, wherein the dependent variables include a diversity rate among employees.

7. The method according to claim 1, wherein the control variables include a market asset value for each of the assets.

8. The method according to claim 1, wherein the actual test values for the governance variables are taken over a test period, and wherein the actual test values for the performance are taken over a delayed period.

9. The method according to claim 8, wherein the delayed period is one year after the test period.

10. The method according to claim 1, wherein the fiduciaries are individuals within a governing group that governs the asset.

11. A system for rating fiduciaries that govern assets, the system comprising:
a collection of governance variables that relate to at least one of environmental and social factors for governing the assets, wherein the governance variables impact financial performance for the assets based on actual test data;
a collection of control variables, wherein the control variables also impact the financial performance for the assets; and
a collection of weight factors that indicate the impacts on the financial performance for the test assets by each of the governance variables and the control variables, wherein the weight factors are based on actual test values for the governance variables, the control variables, and the financial performance for test assets within the assets;
wherein a given fiduciary within the fiduciaries is rated by applying the weight factors to actual asset values collected for the given fiduciary for the governing variables and the control variables.

12. The system according to claim 11, wherein the weight factors are normalized to a 100-point scale for each of the governance variables and the control variables.

13. The system according to claim 11, wherein the fiduciaries are third party organizations.

14. The system according to claim 11, wherein the governance variables include participation by each of the fiduciaries in respective compliance committees.

15. The system according to claim 11, wherein the collection of the actual test values includes data relating to social impact.

16. The system according to claim 15, wherein the data relating to social impact includes a workplace injury rate.

17. The system according to claim 11, wherein the governance variables include independent variables and dependent variables, wherein the dependent variables include an average of vehicle fleet CO2 emissions.

18. The system according to claim 11, wherein the control variables include an annual contribution rate for each of the funds.

19. The system according to claim 11, wherein the actual test values for the governance variables are taken over a test period, and wherein the actual test values for the financial performance are taken over a delayed period.

20. A method for rating fiduciaries that govern funds, the method comprising:
collecting governance variables relating to environmental, social, and governance factors for governing the funds, wherein the governance variables impact financial performance for the funds, and wherein collecting the governance variables includes gathering data from meeting minutes of the fiduciaries;
assigning control variables, wherein the control variables also impact the financial performance for the funds;
compiling a collection of actual test values for the governance variables, the control variables, and the financial performance for test funds within the funds, wherein the actual test values for the governance variables and the control variables are taken over a test period, and wherein the actual test values for the financial performance are taken over a delayed period that is delayed from the test period;
assigning a weight factor indicating the impacts on the financial performance for the test funds by each of the governance variables and the control variables;
normalizing each weight factor of the governance variables and the control variables and correspondingly assigning for each weight factor a normalized weight factor;
constructing a rating model incorporating the governance variables and the control variables with each respective normalized weight factor; and
collecting actual fund values for the governance variables and the control variables for a given fund within the funds; and
rating a given fiduciary within the fiduciaries that governs the given fund by using the rating model with the actual fund values collected.
